(19) United States
(12) Patent Application Publication
(10) Pub. No.: US 2012/0280517 A1
(43) Pub. Date: Nov. 8, 2012

(54) STABLE HYDROGEN-CONTAINING FUELS AND SYSTEMS AND METHODS FOR GENERATING ENERGY THEREFROM

(75) Inventors: James M. HAIR, III, Cheyenne, WY (US); Daniel L. GREENE, Cheyenne, WY (US)

(73) Assignee: eRevolution Technologies, Inc., Henderson, NV (US)

(21) Appl. No.: 13/464,844

(22) Filed: May 4, 2012

Related U.S. Application Data
(60) Provisional application No. 61/483,560, filed on May 6, 2011.

(51) Int. Cl. H02K 7/18; F02C 1/00; F02C 3/20; F02B 43/00; F02G 3/00

(52) U.S. Cl. 290/1 R; 123/3; 60/39.12; 60/39.461; 60/772; 60/775; 290/52

(57) ABSTRACT

Hydrogen-containing fuel/oxidizer combinations, such as aqueous ammonia and aqueous hydrogen peroxide, are disclosed. Systems and methods using such fuel for generation of energy are also disclosed. The reaction products of the fuels are environmentally benign chemicals such as nitrogen gas and water.

### CROSS REFERENCE TO RELATED APPLICATIONS

This patent application claims priority benefit of U.S. Provisional Patent Application No. 61/483,560, filed May 6, 2011. The entire contents of that application are hereby incorporated by reference herein.

### TECHNICAL FIELD

The invention relates to hydrogen-containing fuel/oxidizer combinations, such as aqueous ammonia and aqueous hydrogen peroxide, and systems and methods using such fuel for generation of energy.

### BACKGROUND

There is a pressing need for economical, environmentally sound, safe, and practical fuel alternatives to hydrocarbon-based fuels such as oil and coal. Molecular hydrogen, H₂, has been proposed as one such alternative fuel, as it produces environmentally benign water when burned. However, there are thermodynamic and logistic limitations to producing, transporting, storing, and using hydrogen as a fuel source. Gaseous H₂ would require storage under pressure, and many metals, including steel, become brittle after prolonged exposure to hydrogen, which can result in metal fatigue and fracture. Liquid H₂ can be impractical, as hydrogen boils at −252.8° C. (20.4 K, −423° F.). Furthermore, use of H₂ as a fuel suffers from many of the same problems currently encountered with petroleum-based products, including the difficulties of establishing centralized supplies and addressing challenges of high cost, limited availability, storage and handling problems, high costs of materials, etc.

Other storage forms for hydrogen have been proposed, such as metal hydrides. Metal hydrides significantly increase the weight per unit of energy stored, and are impractical for fuels used in automobiles and other forms of transport. In addition, energy is typically required to separate the hydrogen gas from the metal hydride, reducing the net amount of energy that can be stored.

The present invention obviates these problems by using small-molecule hydrogen-rich chemicals, rather than hydrogen molecules alone. The hydrogen-rich small molecules are not hydrocarbon based, and thus do not depend on non-renewable resources and do not generate appreciable amounts of greenhouse gases upon use. The present invention also provides advantages in storage and transport of fuel.

### DISCLOSURE OF THE INVENTION

In its various embodiments, the invention encompasses systems, methods, and fuels for generation of energy.

In one embodiment, the invention embraces a system for generation of energy, said system comprising a fuel or fuel precursor having a molecular formula comprising nitrogen and hydrogen, said fuel or fuel precursor essentially excluding carbon not already fully oxidized and/or essentially excluding oxidizable carbon and/or when carbon is present in the fuel or fuel precursor, essentially including only non-oxidizable carbon; an oxidizing agent, and a reaction chamber into which the fuel or fuel precursor and oxidizing agent are introduced, or can be introduced, or which is configured to receive the fuel or fuel precursor and oxidizing agent. The fuel or fuel precursor and oxidizing agent can react, are capable of reacting, or are operable to react, in the reaction chamber. The fuel or fuel precursor, the oxidizing agent, or both the fuel or fuel precursor and the oxidizing agent are or can be in fluid form, in liquid form such as in an aqueous solution, in gaseous form, in steam, or in supercritical steam (supercritical water), in solid form, including solids in suspensions in fluid, such as a solid in suspension in liquid or in gas, or in any combination of the foregoing. In some embodiments, the fuel or fuel precursor, the oxidizing agent, or both the fuel or fuel precursor and the oxidizing agent used in the system are, or can be, in an aqueous solution prior to introduction into the reaction chamber. The fuel or fuel precursor and oxidizing agent can react, are capable of reacting, or are operable to react, in the reaction chamber to release energy. In one embodiment, the energy released is or can be released as heat. In another embodiment, the energy released is or can be released as pressure and/or volume change. In another embodiment, the energy released is or can be released as pressure and/or volume change, and as heat. The energy released can be used to heat liquid water to form steam. The energy released can be used to heat liquid water to supercritical steam (supercritical water). The energy released can be used to increase the pressure of a substance, such as a fluid or working fluid, such as a gas or liquid. The energy released can be used to do work.

In other embodiments, the fuel is, or can be, selected from the group consisting of ammonia, ammonia gas, anhydrous ammonia, ammonium hydroxide, ammonium nitrate, ammonium perchlorate, hydroxylamine, hydrazine, ammonium bicarbonate, and ammonium carbonate. In further embodiments, the fuel is, or can be, ammonia or ammonium hydroxide.

In other embodiments, the fuel precursor can be urea.

In other embodiments, the oxidizing agent is, or can be, selected from the group consisting of hydrogen peroxide, nitric acid, nitrous oxide, nitric oxide, nitrogen dioxide, nitrogen tetroxide, and sodium percarbonate. In further embodiments, the oxidizing agent is, or can be, hydrogen peroxide.

In another embodiment, the fuel is, or can be, ammonia or ammonium hydroxide, and the oxidizing agent is, or can be, hydrogen peroxide.

In another embodiment, the fuel precursor is, or can be, urea, and the oxidizing agent is, or can be, hydrogen peroxide.

In some embodiments, the fuel can be a low-carbon fuel.

In other embodiments, the reaction chamber comprises or contains a catalyst or catalysts. The one or more catalysts are, or can be, a main group metal, a main group metal oxide, a transition metal, a transition metal oxide, a heavy metal, a heavy metal oxide, a zinc triad element or zinc triad element oxide; a nickel triad metal or nickel triad metal oxide; a platinum group metal or platinum group metal oxide; a lanthanide or lanthanide oxide; an actinide or actinide oxide; or their alloys; or combinations of any or all of the foregoing. The one or more catalysts are, or can be, catalysts for the decomposition of the oxidizing agent, the decomposition of the fuel or fuel precursor, or the decomposition of both the oxidizing agent and the fuel or fuel precursor. The catalyst(s) is, or can be, a catalyst for the decomposition of hydrogen peroxide, including metallic or metal oxide forms of: main group elements Li, Na, K, Rb, Cs, Be, Mg, Ca, Sr, Ba, B, Al, Ga, In, Si, Ge, Sn, P, Sb, S, and Zn; transition elements Sc, Y, Ti, Zr, Hf; V, Nb, Ta, Cr, Mo, W, Mn, Re, Fe, Ru, Os, Co, Rh, Ir, Ni, Pd, Pt, Cu, Ag, and Au; the lanthanide elements; and actinium; or their alloys; or combinations of any or all of the foregoing. The catalyst(s) is, or can be, a catalyst or catalysts for the decomposition of NH₃ or NH₄OH. The catalyst(s) is, or can be, a catalyst or catalysts for the decomposition of urea. In some embodiments, the reaction chamber comprises at least one catalyst for the decomposition of hydrogen peroxide and at least one catalyst for the decomposition of NH₃ or NH₄OH. In some embodiments, the reaction chamber comprises at least one catalyst for the decomposition of hydrogen peroxide and at least one catalyst for the decomposition of urea. In some embodiments, the reaction chamber comprises at least one catalyst for the decomposition of hydrogen peroxide, at least one catalyst for the decomposition of urea, and at least one catalyst for the decomposition of NH₃ or NH₄OH.

In another embodiment, the invention embraces a system for generation of energy, said system comprising a reservoir of a fuel or fuel precursor, the molecular formula of said fuel or fuel precursor consisting essentially of nitrogen, hydrogen, and optionally oxygen and/or carbonate and/or carbonic acid derivatives and/or fully oxidized carbon; a reservoir of an oxidizing agent, and a reaction chamber into which the fuel or fuel precursor and oxidizing agent are introduced, or can be introduced, or which is configured to receive the fuel or fuel precursor and oxidizing agent. The fuel or fuel precursor and oxidizing agent can react, are capable of reacting, or are operable to react, in the reaction chamber. The fuel or fuel precursor, the oxidizing agent, or the fuel or fuel precursor and the oxidizing agent are, or can be, or are capable of, or are operable to be, reacted in fluid form, in liquid form such as in an aqueous solution, in gaseous form, in steam, or in supercritical steam (supercritical water), in solid form, including solids in suspensions in fluid, such as a solid in suspension in liquid or in gas, or in any combination of the foregoing. In some embodiments, the fuel or fuel precursor, the oxidizing agent, or both the fuel or fuel precursor and the oxidizing agent used in the system are, or can be, in an aqueous solution prior to introduction into the reaction chamber. The fuel or fuel precursor and oxidizing agent can react in the reaction chamber to release energy. In one embodiment, the energy released is, or can be, released as heat. In another embodiment, the energy released is, or can be, released as pressure and/or volume change. In another embodiment, the energy released is, or can be, released as pressure and/or volume change, and as heat. The energy released can be used to heat liquid water to form steam. The energy released can be used to heat liquid water to supercritical steam (supercritical water). The energy released can be used to increase the pressure of a substance, such as a fluid or working fluid, such as a gas or liquid. The energy released can be used to do work.

In other embodiments, the fuel is, or can be, selected from the group consisting of ammonia, ammonia gas, anhydrous ammonia, ammonium hydroxide, ammonium nitrate, ammonium perchlorate, hydroxylamine, hydrazine, ammonium bicarbonate, and ammonium carbonate. In further embodiments, the fuel is, or can be, ammonia or ammonium hydroxide.

In other embodiments, the fuel precursor can be urea.

In other embodiments, the oxidizing agent is, or can be, selected from the group consisting of hydrogen peroxide, nitric acid, nitrous oxide, nitric oxide, nitrogen dioxide, nitrogen tetroxide, and sodium percarbonate. In further embodiments, the oxidizing agent is, or can be, hydrogen peroxide.

In another embodiment, the fuel is, or can be, ammonia or ammonium hydroxide, and the oxidizing agent is, or can be, hydrogen peroxide.

In another embodiment, the fuel precursor is, or can be, urea, and the oxidizing agent is, or can be, hydrogen peroxide.

In some embodiments, the fuel can be a low-carbon fuel.

In other embodiments, the reaction chamber comprises or contains a catalyst or catalysts. The one or more catalysts are, or can be, a main group metal, a main group metal oxide, a transition metal, a transition metal oxide, a heavy metal, a heavy metal oxide, a zinc triad element or zinc triad element oxide; a nickel triad metal or nickel triad metal oxide; a platinum group metal or platinum group metal oxide; a lanthanide or lanthanide oxide; an actinide or actinide oxide; or their alloys; or combinations of any or all of the foregoing. The one or more catalysts are, or can be, catalysts for the decomposition of the oxidizing agent, the decomposition of the fuel or fuel precursor, or the decomposition of both the oxidizing agent and the fuel or fuel precursor. The catalyst(s) is, or can be, a catalyst for the decomposition of hydrogen peroxide, including metallic or metal oxide forms of: main group elements Li, Na, K, Rb, Cs, Be, Mg, Ca, Sr, Ba, B, Al, Ga, In, Si, Ge, Sn, P, Sb, S, and Zn; transition elements Sc, Y, Ti, Zr, Hf; V, Nb, Ta, Cr, Mo, W, Mn, Re, Fe, Ru, Os, Co, Rh, Ir, Ni, Pd, Pt, Cu, Ag, and Au; the lanthanide elements; and actinium; or their alloys; or combinations of any or all of the foregoing. The catalyst(s) is, or can be, a catalyst or catalysts for the decomposition of NH₃ or NH₄OH. In some embodiments, the reaction chamber comprises at least one catalyst for the decomposition of hydrogen peroxide and at least one catalyst for the decomposition of NH₃ or NH₄OH. In some embodiments, the reaction chamber comprises at least one catalyst for the decomposition of hydrogen peroxide and at least one catalyst for the decomposition of urea. In some embodiments, the reaction chamber comprises at least one catalyst for the decomposition of hydrogen peroxide, at least one catalyst for the decomposition of urea, and at least one catalyst for the decomposition of NH₃ or NH₄OH.

In another embodiment, the invention embraces a system comprising a fuel or fuel precursor having a molecular formula comprising nitrogen and hydrogen, said fuel or fuel precursor essentially excluding carbon not already fully oxidized and/or essentially excluding oxidizable carbon and/or when carbon is present in the fuel or fuel precursor, essentially including only non-oxidizable carbon; an oxidizing agent; and a reaction chamber into which the fuel or fuel precursor and oxidizing agent are introduced, or can be introduced, or which is configured to receive the fuel or fuel precursor and oxidizing agent, where the fuel or fuel precursor and oxidizing agent can react, are capable of reacting, or are operable to react, in the reaction chamber; and where the reaction chamber is a combustion chamber or expansion chamber of an internal combustion engine. In some embodiments, the molecular formula of the fuel or fuel precursor consists essentially of nitrogen, hydrogen, and optionally oxygen and/or carbonate and/or carbonic acid derivatives and/or fully oxidized carbon. In some embodiments, the fuel or fuel precursor and oxidizing agent are, or can be, introduced and are, or can be, reacted in fluid form, in liquid form such as in an aqueous solution, in gaseous form, in steam, or in supercritical steam (supercritical water), in solid form, including solids in suspensions in fluid, such as a solid in suspension in liquid or in gas, or in any combination of the foregoing. In some embodiments, the fuel or fuel precursor, the oxidizing agent, or both the fuel or fuel precursor and the oxidizing agent used in the system are, or can be, in an aqueous solution prior to introduction into the reaction chamber. The fuel or fuel precursor and oxidizing agent react, or can react, in the reaction chamber to release energy. In one embodiment, the energy released is, or can be, released as heat. In another embodiment, the energy released is, or can be, released as pressure and/or volume change. In another embodiment, the energy released is, or can be, released as pressure and/or volume change, and as heat. The energy released can be used to increase the pressure of a substance, such as a fluid or working fluid, such as a gas or liquid. The energy released can be used to do work. In some embodiments, the fuel or fuel precursor and oxidizing agent are, or can be, introduced and reacted in fluid form, in liquid form such as in an aqueous solution, in gaseous form, in steam, or in supercritical steam (supercritical water), in solid form, including solids in suspensions in fluid, such as a solid in suspension in liquid or in gas, or in any combination of the foregoing. In some embodiments, the fuel or fuel precursor and oxidizing agent are, or can be, introduced and reacted in an aqueous solution or in steam. The energy released can be used to heat liquid water to form steam. The energy released can be used to heat liquid water to supercritical steam (supercritical water).

In further embodiments, the combustion chamber or expansion chamber of an internal combustion engine is selected from the group consisting of a combustion chamber or expansion chamber of a piston engine, a combustion chamber or expansion chamber of a rotary engine, and a combustion chamber or expansion chamber of a turbine. In some embodiments, when the oxidizing agent is hydrogen peroxide, the combustion chamber or expansion chamber of the internal combustion engine further comprises or contains a catalyst or catalysts for decomposition of hydrogen peroxide.

In other embodiments, the fuel is, or can be, selected from the group consisting of ammonia, ammonia gas, anhydrous ammonia, ammonium hydroxide, ammonium nitrate, ammonium perchlorate, hydroxylamine, hydrazine, ammonium bicarbonate, and ammonium carbonate. In further embodiments, the fuel is, or can be, ammonia or ammonium hydroxide.

In other embodiments, the fuel precursor can be urea.

In other embodiments, the oxidizing agent is, or can be, selected from the group consisting of hydrogen peroxide, nitric acid, nitrous oxide, nitric oxide, nitrogen dioxide, nitrogen tetroxide, and sodium percarbonate. In further embodiments, the oxidizing agent is, or can be, hydrogen peroxide.

In another embodiment, the fuel is, or can be, ammonia or ammonium hydroxide, and the oxidizing agent is, or can be, hydrogen peroxide.

In another embodiment, the fuel precursor is, or can be, urea, and the oxidizing agent is, or can be, hydrogen peroxide.

In some embodiments, the fuel can be a low-carbon fuel.

In other embodiments, the combustion chamber or expansion chamber of the internal combustion engine comprises or contains a catalyst or catalysts. The one or more catalysts are, or can be, a main group metal, a main group metal oxide, a transition metal, a transition metal oxide, a heavy metal, a heavy metal oxide, a zinc triad element or zinc triad element oxide; a nickel triad metal or nickel triad metal oxide; a platinum group metal or platinum group metal oxide; a lanthanide or lanthanide oxide; an actinide or actinide oxide; or their alloys; or combinations of any or all of the foregoing. The one or more catalysts are, or can be, catalysts for the decomposition of the oxidizing agent, the decomposition of the fuel or fuel precursor, or the decomposition of both the oxidizing agent and the fuel or fuel precursor. The catalyst(s) is, or can be, a catalyst for the decomposition of hydrogen peroxide, including metallic or metal oxide forms of: main group elements Li, Na, K, Rb, Cs, Be, Mg, Ca, Sr, Ba, B, Al, Ga, In, Si, Ge, Sn, P, Sb, S, and Zn; transition elements Sc, Y, Ti, Zr, Hf; V, Nb, Ta, Cr, Mo, W, Mn, Re, Fe, Ru, Os, Co, Rh, Ir, Ni, Pd, Pt, Cu, Ag, and Au; the lanthanide elements; and actinium; or their alloys; or combinations of any or all of the foregoing. The catalyst(s) is, or can be, a catalyst or catalysts for the decomposition of NH₃ or NH₄OH. In some embodiments, the reaction chamber comprises at least one catalyst for the decomposition of hydrogen peroxide and at least one catalyst for the decomposition of NH₃ or NH₄OH. In some embodiments, the reaction chamber comprises at least one catalyst for the decomposition of hydrogen peroxide and at least one catalyst for the decomposition of urea. In some embodiments, the reaction chamber comprises at least one catalyst for the decomposition of hydrogen peroxide, at least one catalyst for the decomposition of urea, and at least one catalyst for the decomposition of NH₃ or NH₄OH.

In other embodiments, the combustion chamber or expansion chamber of the internal combustion engine comprises or contains a catalyst or catalysts. The catalyst(s) is, or can be, one or more catalysts for the decomposition of hydrogen peroxide, such as a transition metal oxide or a heavy metal oxide; one or more catalysts for decomposition of ammonia or ammonium hydroxide; or both one or more catalysts for the decomposition of hydrogen peroxide and one or more catalysts for decomposition of ammonia or ammonium hydroxide.

In another embodiment, the invention embraces a system for generation of energy, said system comprising a fuel or fuel precursor having a molecular formula comprising nitrogen and hydrogen, said fuel or fuel precursor essentially excluding carbon not already fully oxidized and/or essentially excluding oxidizable carbon and/or when carbon is present in the fuel or fuel precursor, essentially including only non-oxidizable carbon; an oxidizing agent; a reaction chamber into which the fuel or fuel precursor and oxidizing agent are introduced, or can be introduced, or which is configured to receive the fuel or fuel precursor and oxidizing agent; and a working fluid to which heat is transferred from the reaction chamber. In some embodiments, the molecular formula of the fuel or fuel precursor consists essentially of nitrogen, hydrogen, and optionally oxygen and/or carbonate and/or carbonic acid derivatives and/or fully oxidized carbon. In further embodiments, the working fluid is the working fluid of an external combustion engine. In some embodiments, the external combustion engine is a steam turbine. In some embodiments, the external combustion engine is a steam engine. In some embodiments, the steam engine is a piston steam engine. In some embodiments, the steam engine is a rotary steam engine. In some embodiments, the engine is a heat engine, air engine, or Stirling engine.

In some embodiments, the fuel or fuel precursor, the oxidizing agent, or both the fuel or fuel precursor and the oxidizing agent used in the system are, or can be, in an aqueous solution prior to introduction into the reaction chamber. The fuel or fuel precursor and oxidizing agent can react, are capable of reacting, or are operable to react, in the reaction chamber to release energy. In some embodiments, the fuel or fuel precursor and oxidizing agent are, or can be, introduced and reacted in fluid form, in liquid form such as in an aqueous solution, in gaseous form, in steam, or in supercritical steam (supercritical water), in solid form, including solids in suspensions in fluid, such as a solid in suspension in liquid or in gas, or in any combination of the foregoing. In some embodiments, the fuel or fuel precursor and oxidizing agent are, or can be, introduced and reacted in an aqueous solution or in steam. In one embodiment, the energy released is, or can be, released as heat. In another embodiment, the energy released is, or can be, released as pressure and/or volume change. In another embodiment, the energy released is, or can be, released as pressure and/or volume change, and as heat. The energy released can be used to heat liquid water to form steam. The energy released can be used to heat liquid water to supercritical steam (supercritical water). The energy released can be used to increase the pressure of a substance, such as a fluid or working fluid, such as a gas or liquid. The energy released can be used to do work.

In other embodiments, the fuel is, or can be, selected from the group consisting of ammonia, ammonia gas, anhydrous ammonia, ammonium hydroxide, ammonium nitrate, ammonium perchlorate, hydroxylamine, hydrazine, ammonium bicarbonate, and ammonium carbonate. In further embodiments, the fuel is, or can be, ammonia or ammonium hydroxide.

In other embodiments, the fuel precursor can be urea.

In other embodiments, the oxidizing agent is, or can be, selected from the group consisting of hydrogen peroxide, nitric acid, nitrous oxide, nitric oxide, nitrogen dioxide, nitrogen tetroxide, and sodium percarbonate. In further embodiments, the oxidizing agent is, or can be, hydrogen peroxide.

In another embodiment, the fuel is, or can be, ammonia or ammonium hydroxide, and the oxidizing agent is, or can be, hydrogen peroxide.

In another embodiment, the fuel precursor is, or can be, urea, and the oxidizing agent is, or can be, hydrogen peroxide.

In some embodiments, the fuel can be a low-carbon fuel.

In other embodiments, the reaction chamber comprises or contains a catalyst or catalysts. The one or more catalysts are, or can be, a main group metal, a main group metal oxide, a transition metal, a transition metal oxide, a heavy metal, a heavy metal oxide, a zinc triad element or zinc triad element oxide; a nickel triad metal or nickel triad metal oxide; a platinum group metal or platinum group metal oxide; a lanthanide or lanthanide oxide; an actinide or actinide oxide; or their alloys; or combinations of any or all of the foregoing. The one or more catalysts are, or can be, catalysts for the decomposition of the oxidizing agent, the decomposition of the fuel or fuel precursor, or the decomposition of both the oxidizing agent and the fuel or fuel precursor. The catalyst(s) is, or can be, a catalyst for the decomposition of hydrogen peroxide, including metallic or metal oxide forms of: main group elements Li, Na, K, Rb, Cs, Be, Mg, Ca, Sr, Ba, B, Al, Ga, In, Si, Ge, Sn, P, Sb, S, and Zn; transition elements Sc, Y, Ti, Zr, Hf; V, Nb, Ta, Cr, Mo, W, Mn, Re, Fe, Ru, Os, Co, Rh, Ir, Ni, Pd, Pt, Cu, Ag, and Au; the lanthanide elements; and actinium; or their alloys; or combinations of any or all of the foregoing. The catalyst(s) is, or can be, a catalyst or catalysts for the decomposition of NH₃ or NH₄OH. In some embodiments, the reaction chamber comprises at least one catalyst for the decomposition of hydrogen peroxide and at least one catalyst for the decomposition of NH₃ or NH₄OH. In some embodiments, the reaction chamber comprises at least one catalyst for the decomposition of hydrogen peroxide and at least one catalyst for the decomposition of urea. In some embodiments, the reaction chamber comprises at least one catalyst for the decomposition of hydrogen peroxide, at least one catalyst for the decomposition of urea, and at least one catalyst for the decomposition of NH₃ or NH₄OH.

In another embodiment, the invention embraces a system for generation of energy, said system comprising a fuel or fuel precursor having a molecular formula comprising nitrogen and hydrogen, said fuel or fuel precursor essentially excluding carbon not already fully oxidized and/or essentially excluding oxidizable carbon and/or when carbon is present in the fuel or fuel precursor, essentially including only non-oxidizable carbon; an oxidizing agent, and a reaction chamber into which the fuel or fuel precursor and oxidizing agent are introduced, or can be introduced, or which is configured to receive the fuel or fuel precursor and oxidizing agent; with the proviso that the system is not a reaction engine or rocket engine. In some embodiments, the molecular formula of the fuel or fuel precursor consists essentially of nitrogen, hydrogen, and optionally oxygen and/or carbonate and/or carbonic acid derivatives and/or fully oxidized carbon.

In some embodiments, the fuel or fuel precursor, the oxidizing agent, or both the fuel or fuel precursor and the oxidizing agent used in the system are, or can be, in an aqueous solution prior to introduction into the reaction chamber. The fuel or fuel precursor and oxidizing agent can react, are capable of reacting, or are operable to react, in the reaction chamber to release energy. In some embodiments, the fuel or fuel precursor and oxidizing agent are, or can be, introduced and reacted in fluid form, in liquid form such as in an aqueous solution, in gaseous form, in steam, or in supercritical steam (supercritical water), in solid form, including solids in suspensions in fluid, such as a solid in suspension in liquid or in gas, or in any combination of the foregoing. In some embodiments, the fuel or fuel precursor and oxidizing agent are, or can be, introduced and reacted in an aqueous solution or in steam. In one embodiment, the energy released is, or can be, released as heat. In another embodiment, the energy released is, or can be, released as pressure and/or volume change. In another embodiment, the energy released is, or can be, released as pressure and/or volume change, and as heat. The energy released can be used to heat liquid water to form steam. The energy released can be used to heat liquid water to supercritical steam (supercritical water). The energy released can be used to increase the pressure of a substance, such as a fluid or working fluid, such as a gas or liquid. The energy released can be used to do work.

In other embodiments, the fuel is, or can be, selected from the group consisting of ammonia, ammonia gas, anhydrous ammonia, ammonium hydroxide, ammonium nitrate, ammonium perchlorate, hydroxylamine, hydrazine, ammonium bicarbonate, and ammonium carbonate. In further embodiments, the fuel is, or can be, ammonia or ammonium hydroxide.

In other embodiments, the fuel precursor can be urea.

In other embodiments, the oxidizing agent is, or can be, selected from the group consisting of hydrogen peroxide, nitric acid, nitrous oxide, nitric oxide, nitrogen dioxide, nitrogen tetroxide, and sodium percarbonate. In further embodiments, the oxidizing agent is, or can be, hydrogen peroxide.

In another embodiment, the fuel is, or can be, ammonia or ammonium hydroxide, and the oxidizing agent is, or can be, hydrogen peroxide.

In another embodiment, the fuel precursor is, or can be, urea, and the oxidizing agent is, or can be, hydrogen peroxide.

In some embodiments, the fuel can be a low-carbon fuel.

In other embodiments, the reaction chamber comprises or contains a catalyst or catalysts. The one or more catalysts are, or can be, a main group metal, a main group metal oxide, a transition metal, a transition metal oxide, a heavy metal, a heavy metal oxide, a zinc triad element or zinc triad element oxide; a nickel triad metal or nickel triad metal oxide; a platinum group metal or platinum group metal oxide; a lanthanide or lanthanide oxide; an actinide or actinide oxide; or their alloys; or combinations of any or all of the foregoing. The one or more catalysts are, or can be, catalysts for the decomposition of the oxidizing agent, the decomposition of the fuel or fuel precursor, or the decomposition of both the oxidizing agent and the fuel or fuel precursor. The catalyst(s) is, or can be, a catalyst for the decomposition of hydrogen peroxide, including metallic or metal oxide forms of: main group elements Li, Na, K, Rb, Cs, Be, Mg, Ca, Sr, Ba, B, Al, Ga, In, Si, Ge, Sn, P, Sb, S, and Zn; transition elements Sc, Y, Ti, Zr, Hf; V, Nb, Ta, Cr, Mo, W, Mn, Re, Fe, Ru, Os, Co, Rh, Ir, Ni, Pd, Pt, Cu, Ag, and Au; the lanthanide elements; and actinium; or their alloys; or combinations of any or all of the foregoing. The catalyst(s) is, or can be, a catalyst or catalysts for the decomposition of NH₃ or NH₄OH. In some embodiments, the reaction chamber comprises at least one catalyst for the decomposition of hydrogen peroxide and at least one catalyst for the decomposition of NH₃ or NH₄OH. In some embodiments, the reaction chamber comprises at least one catalyst for the decomposition of hydrogen peroxide and at least one catalyst for the decomposition of urea. In some embodiments, the reaction chamber comprises at least one catalyst for the decomposition of hydrogen peroxide, at least one catalyst for the decomposition of urea, and at least one catalyst for the decomposition of NH₃ or NH₄OH.

In further embodiments, the invention embraces a system for generation of pressurized gas or pressurized vapor, said system comprising a fuel or fuel precursor having a molecular formula comprising nitrogen and hydrogen, said fuel or fuel precursor essentially excluding carbon not already fully oxidized and/or essentially excluding oxidizable carbon and/or when carbon is present in the fuel or fuel precursor, essentially including only non-oxidizable carbon; an oxidizing agent, and a reaction chamber into which the fuel or fuel precursor and oxidizing agent are introduced, or can be introduced, or which is configured to receive the fuel or fuel precursor and oxidizing agent; and in which the fuel or fuel precursor and oxidizing agent can react, are capable of reacting, or are operable to react, to form pressurized gas or pressurized vapor. In one embodiment, at least one additional substance can be introduced into the reaction chamber to form pressurized gas or pressurized vapor. In some embodiments, the molecular formula of the fuel or fuel precursor consists essentially of nitrogen, hydrogen, and optionally oxygen and/or carbonate and/or carbonic acid derivatives and/or fully oxidized carbon.

In some embodiments, the fuel or fuel precursor, the oxidizing agent, or both the fuel or fuel precursor and the oxidizing agent used in the system are, or can be, in an aqueous solution prior to introduction into the reaction chamber. The fuel or fuel precursor and oxidizing agent can react, are capable of reacting, or are operable to react, in the reaction chamber to release energy. In some embodiments, the fuel or fuel precursor and oxidizing agent are, or can be, introduced and reacted in fluid form, in liquid form such as in an aqueous solution, in gaseous form, in steam, or in supercritical steam (supercritical water), in solid form, including solids in suspensions in fluid, such as a solid in suspension in liquid or in gas, or in any combination of the foregoing. In some embodiments, the fuel or fuel precursor and oxidizing agent are, or can be, introduced and reacted in an aqueous solution or in steam. In one embodiment, the energy released is, or can be, released as heat. In another embodiment, the energy released is, or can be, released as pressure and/or volume change. In another embodiment, the energy released is, or can be, released as pressure and/or volume change, and as heat. The energy released can be used to heat liquid water to form steam. The energy released can be used to heat liquid water to supercritical steam (supercritical water). The energy released can be used to increase the pressure of a substance, such as a fluid or working fluid, such as a gas or liquid. The energy released can be used to do work.

In other embodiments, the fuel is, or can be, selected from the group consisting of ammonia, ammonia gas, anhydrous ammonia, ammonium hydroxide, ammonium nitrate, ammonium perchlorate, hydroxylamine, hydrazine, ammonium bicarbonate, and ammonium carbonate. In further embodiments, the fuel is, or can be, ammonia or ammonium hydroxide.

In other embodiments, the fuel precursor can be urea.

In other embodiments, the oxidizing agent is, or can be, selected from the group consisting of hydrogen peroxide, nitric acid, nitrous oxide, nitric oxide, nitrogen dioxide, nitrogen tetroxide, and sodium percarbonate. In further embodiments, the oxidizing agent is, or can be, hydrogen peroxide.

In another embodiment, the fuel is, or can be, ammonia or ammonium hydroxide, and the oxidizing agent is, or can be, hydrogen peroxide.

In another embodiment, the fuel precursor is, or can be, urea, and the oxidizing agent is, or can be, hydrogen peroxide.

In some embodiments, the fuel can be a low-carbon fuel.

In other embodiments, the reaction chamber comprises or contains a catalyst or catalysts. The one or more catalysts are, or can be, a main group metal, a main group metal oxide, a transition metal, a transition metal oxide, a heavy metal, a heavy metal oxide, a zinc triad element or zinc triad element oxide; a nickel triad metal or nickel triad metal oxide; a platinum group metal or platinum group metal oxide; a lanthanide or lanthanide oxide; an actinide or actinide oxide; or their alloys; or combinations of any or all of the foregoing. The one or more catalysts are, or can be, catalysts for the decomposition of the oxidizing agent, the decomposition of the fuel or fuel precursor, or the decomposition of both the oxidizing agent and the fuel or fuel precursor. The catalyst(s) is, or can be, a catalyst for the decomposition of hydrogen peroxide, including metallic or metal oxide forms of: main group elements Li, Na, K, Rb, Cs, Be, Mg, Ca, Sr, Ba, B, Al, Ga, In, Si, Ge, Sn, P, Sb, S, and Zn; transition elements Sc, Y, Ti, Zr, Hf; V, Nb, Ta, Cr, Mo, W, Mn, Re, Fe, Ru, Os, Co, Rh, Ir, Ni, Pd, Pt, Cu, Ag, and Au; the lanthanide elements; and actinium; or their alloys; or combinations of any or all of the foregoing. The catalyst(s) is, or can be, a catalyst or catalysts for the decomposition of NH₃ or NH₄OH. In some embodiments, the reaction chamber comprises at least one catalyst for the decomposition of hydrogen peroxide and at least one catalyst for the decomposition of NH₃ or NH₄OH. In some embodiments, the reaction chamber comprises at least one catalyst for the decomposition of hydrogen peroxide and at least one catalyst for the decomposition of urea. In some embodiments, the reaction chamber comprises at least one catalyst for the decomposition of hydrogen peroxide, at least one catalyst for the decomposition of urea, and at least one catalyst for the decomposition of NH₃ or NH₄OH.

In further embodiments, the invention embraces a method for generation of pressurized gas or pressurized vapor, said method comprising the steps of introducing a fuel or fuel precursor and an oxidizing agent into a reaction chamber, wherein the fuel or fuel precursor and oxidizing agent can be introduced sequentially in any order, simultaneously, or during overlapping periods of time, wherein the molecular formula of the fuel or fuel precursor comprises nitrogen and hydrogen and essentially excludes carbon not already fully oxidized; and reacting the fuel or fuel precursor and oxidizing agent to form pressurized gas or pressurized vapor. In one embodiment, the method further comprises introducing at least one additional substance into the reaction chamber before, during, or after introducing the fuel or fuel precursor and/or oxidizing agent into the reaction chamber; and transforming the at least one additional substance into a pressurized gas or pressurized vapor. In some embodiments, the molecular formula of the fuel or fuel precursor consists essentially of nitrogen, hydrogen, and optionally oxygen and/or carbonate and/or carbonic acid derivatives and/or fully oxidized carbon.

In some embodiments of the system and method for generation of pressurized gas or pressurized vapor, the at least one additional substance is a liquid, and the transforming of the at least one additional substance into a pressurized gas or pressurized vapor comprises evaporating the liquid. In further embodiments, the liquid comprises water.

In some embodiments of the system and method for generation of pressurized gas or pressurized vapor, the at least one additional substance is a gas, and the transforming of the at least one additional substance into a pressurized gas or pressurized vapor comprises raising the pressure of the introduced gaseous additional substance by transfer of energy to the at least one additional substance. In further embodiments, the at least one additional substance is low-pressure steam. In further embodiments, the at least one additional substance is supplemental steam. In further embodiments, the at least one additional substance is supplemental water.

In some embodiments of the system and method for generation of pressurized gas or pressurized vapor, the pressurized gas or pressurized vapor generated is at a pressure at or above about 50 bar.

In some embodiments, the fuel or fuel precursor, the oxidizing agent, or both the fuel or fuel precursor and the oxidizing agent used in the system are, or can be, in an aqueous solution prior to introduction into the reaction chamber. The fuel or fuel precursor and oxidizing agent react in the reaction chamber to release energy. In some embodiments, the fuel or fuel precursor and oxidizing agent are, or can be, introduced and reacted in fluid form, in liquid form such as in an aqueous solution, in gaseous form, in steam, or in supercritical steam (supercritical water), in solid form, including solids in suspensions in fluid, such as a solid in suspension in liquid or in gas, or in any combination of the foregoing. In some embodiments, the fuel or fuel precursor and oxidizing agent are, or can be, introduced and reacted in an aqueous solution or in steam. In one embodiment, the energy released is, or can be, released as heat. In another embodiment, the energy released is, or can be, released as pressure and/or volume change. In another embodiment, the energy released is, or can be, released as pressure and/or volume change, and as heat. The energy released can be used to heat liquid water to form steam. The energy released can be used to heat liquid water to supercritical steam (supercritical water). The energy released can be used to increase the pressure of a substance, such as a fluid or working fluid, such as a gas or liquid. The energy released can be used to do work.

In other embodiments, the fuel is, or can be, selected from the group consisting of ammonia, ammonia gas, anhydrous ammonia, ammonium hydroxide, ammonium nitrate, ammonium perchlorate, hydroxylamine, hydrazine, ammonium bicarbonate, and ammonium carbonate. In further embodiments, the fuel is, or can be, ammonia or ammonium hydroxide.

In other embodiments, the fuel precursor can be urea.

In other embodiments, the oxidizing agent is, or can be, selected from the group consisting of hydrogen peroxide, nitric acid, nitrous oxide, nitric oxide, nitrogen dioxide, nitrogen tetroxide, and sodium percarbonate. In further embodiments, the oxidizing agent is, or can be, hydrogen peroxide.

In another embodiment, the fuel is, or can be, ammonia or ammonium hydroxide, and the oxidizing agent is, or can be, hydrogen peroxide.

In another embodiment, the fuel precursor is, or can be, urea, and the oxidizing agent is, or can be, hydrogen peroxide.

In some embodiments, the fuel can be a low-carbon fuel.

In other embodiments, the reaction chamber comprises or contains a catalyst or catalysts. The one or more catalysts are, or can be, a main group metal, a main group metal oxide, a transition metal, a transition metal oxide, a heavy metal, a heavy metal oxide, a zinc triad element or zinc triad element oxide; a nickel triad metal or nickel triad metal oxide; a platinum group metal or platinum group metal oxide; a lanthanide or lanthanide oxide; an actinide or actinide oxide; or their alloys; or combinations of any or all of the foregoing. The one or more catalysts are, or can be, catalysts for the decomposition of the oxidizing agent, the decomposition of the fuel or fuel precursor, or the decomposition of both the oxidizing agent and the fuel or fuel precursor. The catalyst(s) is, or can be, a catalyst for the decomposition of hydrogen peroxide, including metallic or metal oxide forms of: main group elements Li, Na, K, Rb, Cs, Be, Mg, Ca, Sr, Ba, B, Al, Ga, In, Si, Ge, Sn, P, Sb, S, and Zn; transition elements Sc, Y, Ti, Zr, Hf; V, Nb, Ta, Cr, Mo, W, Mn, Re, Fe, Ru, Os, Co, Rh, Ir, Ni, Pd, Pt, Cu, Ag, and Au; the lanthanide elements; and actinium; or their alloys; or combinations of any or all of the foregoing. The catalyst(s) is, or can be, a catalyst or catalysts for the decomposition of NH₃ or NH₄OH. In some embodiments, the reaction chamber comprises at least one catalyst for the decomposition of hydrogen peroxide and at least one catalyst for the decomposition of NH₃ or NH₄OH. In some embodiments, the reaction chamber comprises at least one catalyst for the decomposition of hydrogen peroxide and at least one catalyst for the decomposition of urea. In some embodiments, the reaction chamber comprises at least one catalyst for the decomposition of hydrogen peroxide, at least one catalyst for the decomposition of urea, and at least one catalyst for the decomposition of NH₃ or NH₄OH.

In further embodiments, the invention embraces a system and method for generation of high-temperature gas or high-temperature vapor, said system comprising a fuel or fuel precursor having a molecular formula comprising nitrogen and hydrogen, said fuel or fuel precursor essentially excluding carbon not already fully oxidized and/or essentially excluding oxidizable carbon and/or when carbon is present in the fuel or fuel precursor, essentially including only non-oxidizable carbon; an oxidizing agent, and a reaction chamber into which the fuel or fuel precursor and oxidizing agent can be introduced; and reacting the fuel or fuel precursor and oxidizing agent to form high-temperature gas or high-temperature vapor. In one embodiment, at least one additional substance can be introduced into the reaction chamber to form high-temperature gas or high-temperature vapor. In some embodiments, the molecular formula of the fuel or fuel precursor consists essentially of nitrogen, hydrogen, and optionally oxygen and/or carbonate and/or carbonic acid derivatives and/or fully oxidized carbon.

In further embodiments, the invention embraces a method for generation of high-temperature gas or high-temperature vapor, said method comprising the steps of introducing a fuel or fuel precursor and an oxidizing agent into a reaction chamber, wherein the fuel or fuel precursor and oxidizing agent can be introduced sequentially in any order, simultaneously, or during overlapping periods of time, wherein the molecular formula of the fuel or fuel precursor comprises nitrogen and hydrogen and essentially excludes carbon not already fully oxidized; and reacting the fuel or fuel precursor and oxidizing agent to form high-temperature gas or high-temperature vapor. In one embodiment, the method further comprises introducing at least one additional substance into the reaction chamber before, during, or after introducing the fuel or fuel precursor and/or oxidizing agent into the reaction chamber; and transforming the at least one additional substance into a high-temperature gas or high-temperature vapor. In some embodiments, the molecular formula of the fuel or fuel precursor consists essentially of nitrogen, hydrogen, and optionally oxygen and/or carbonate and/or carbonic acid derivatives and/or fully oxidized carbon.

In further embodiments of the system and method for generation of high-temperature gas or high-temperature vapor, the at least one additional substance introduced is a liquid, and the transforming of the at least one additional substance into a high-temperature gas or high-temperature vapor comprises evaporating the liquid. In some embodiments, the liquid additional substance comprises water.

In further embodiments of the system and method for generation of high-temperature gas or high-temperature vapor, the at least one additional substance introduced is a gas, and the transforming of the at least one additional substance into a high-temperature gas or high-temperature vapor comprises raising the temperature of the introduced gaseous additional substance by transfer of energy to the additional substance. In some embodiments, the at least one additional substance is low-temperature steam.

In some embodiments of the system and method for generation of a high-temperature gas or high-temperature vapor, the high-temperature gas or high-temperature vapor is at a temperature at or above about 200° C.

In some embodiments, the fuel or fuel precursor, the oxidizing agent, or both the fuel or fuel precursor and the oxidizing agent used in the system are, or can be, in an aqueous solution prior to introduction into the reaction chamber. The fuel or fuel precursor and oxidizing agent react in the reaction chamber to release energy. In some embodiments, the fuel or fuel precursor and oxidizing agent are, or can be, introduced and reacted in fluid form, in liquid form such as in an aqueous solution, in gaseous form, in steam, or in supercritical steam (supercritical water), in solid form, including solids in suspensions in fluid, such as a solid in suspension in liquid or in gas, or in any combination of the foregoing. In some embodiments, the fuel or fuel precursor and oxidizing agent are, or can be, introduced and reacted in an aqueous solution or in steam. In one embodiment, the energy released is, or can be, released as heat. In another embodiment, the energy released is, or can be, released as pressure and/or volume change. In another embodiment, the energy released is, or can be, released as pressure and/or volume change, and as heat. The energy released can be used to heat liquid water to form steam. The energy released can be used to heat liquid water to supercritical steam (supercritical water). The energy released can be used to increase the pressure of a substance, such as a fluid or working fluid, such as a gas or liquid. The energy released can be used to do work.

In other embodiments, the fuel is, or can be, selected from the group consisting of ammonia, ammonia gas, anhydrous ammonia, ammonium hydroxide, ammonium nitrate, ammonium perchlorate, hydroxylamine, hydrazine, ammonium bicarbonate, and ammonium carbonate. In further embodiments, the fuel is, or can be, ammonia or ammonium hydroxide.

In other embodiments, the fuel precursor can be urea.

In other embodiments, the oxidizing agent is, or can be, selected from the group consisting of hydrogen peroxide, nitric acid, nitrous oxide, nitric oxide, nitrogen dioxide, nitrogen tetroxide, and sodium percarbonate. In further embodiments, the oxidizing agent is, or can be, hydrogen peroxide.

In another embodiment, the fuel is, or can be, ammonia or ammonium hydroxide, and the oxidizing agent is, or can be, hydrogen peroxide.

In another embodiment, the fuel precursor is, or can be, urea, and the oxidizing agent is, or can be, hydrogen peroxide.

In some embodiments, the fuel can be a low-carbon fuel.

In other embodiments, the reaction chamber comprises or contains a catalyst or catalysts. The one or more catalysts are, or can be, a main group metal, a main group metal oxide, a transition metal, a transition metal oxide, a heavy metal, a heavy metal oxide, a zinc triad element or zinc triad element oxide; a nickel triad metal or nickel triad metal oxide; a platinum group metal or platinum group metal oxide; a lanthanide or lanthanide oxide; an actinide or actinide oxide; or their alloys; or combinations of any or all of the foregoing. The one or more catalysts are, or can be, catalysts for the decomposition of the oxidizing agent, the decomposition of the fuel or fuel precursor, or the decomposition of both the oxidizing agent and the fuel or fuel precursor. The catalyst(s) is, or can be, a catalyst for the decomposition of hydrogen peroxide, including metallic or metal oxide forms of: main group elements Li, Na, K, Rb, Cs, Be, Mg, Ca, Sr, Ba, B, Al, Ga, In, Si, Ge, Sn, P, Sb, S, and Zn; transition elements Sc, Y, Ti, Zr, Hf; V, Nb, Ta, Cr, Mo, W, Mn, Re, Fe, Ru, Os, Co, Rh, Ir, Ni, Pd, Pt, Cu, Ag, and Au; the lanthanide elements; and actinium; or their alloys; or combinations of any or all of the foregoing. The catalyst(s) is, or can be, a catalyst or catalysts for the decomposition of NH₃ or NH₄OH. In some embodiments, the reaction chamber comprises at least one catalyst for the decomposition of hydrogen peroxide and at least one catalyst for the decomposition of NH₃ or NH₄OH. In some embodiments, the reaction chamber comprises at least one catalyst for the decomposition of hydrogen peroxide and at least one catalyst for the decomposition of urea. In some embodiments, the reaction chamber comprises at least one catalyst for the decomposition of hydrogen peroxide, at least one catalyst for the decomposition of urea, and at least one catalyst for the decomposition of NH₃ or NH₄OH.

In further embodiments, the invention embraces a system and method for generation of a supercritical fluid, said system comprising a fuel or fuel precursor having a molecular formula comprising nitrogen and hydrogen, said fuel or fuel precursor essentially excluding carbon not already fully oxidized and/or essentially excluding oxidizable carbon and/or when carbon is present in the fuel or fuel precursor, essentially including only non-oxidizable carbon; an oxidizing agent, and a reaction chamber into which the fuel or fuel precursor and oxidizing agent can be introduced; and reacting the fuel or fuel precursor and oxidizing agent to form a supercritical fluid. In one embodiment, at least one additional substance can be introduced into the reaction chamber to form a supercritical fluid. In some embodiments, the molecular formula of the fuel or fuel precursor consists essentially of nitrogen, hydrogen, and optionally oxygen and/or carbonate and/or carbonic acid derivatives and/or fully oxidized carbon.

In further embodiments, the invention embraces a method for generation of supercritical fluid, said method comprising the steps of introducing a fuel or fuel precursor and an oxidizing agent into a reaction chamber, wherein the fuel or fuel precursor and oxidizing agent can be introduced sequentially in any order, simultaneously, or during overlapping periods of time, wherein the molecular formula of the fuel or fuel precursor comprises nitrogen and hydrogen and essentially excludes carbon not already fully oxidized and/or essentially excludes oxidizable carbon and/or essentially includes only non-oxidizable carbon; and reacting the fuel or fuel precursor and oxidizing agent to form a supercritical fluid. In one embodiment, the method further comprises introducing at least one additional substance into the reaction chamber before, during, or after introducing the fuel or fuel precursor and/or oxidizing agent into the reaction chamber; and transforming the at least one additional substance into supercritical fluid. In some embodiments, the molecular formula of the fuel or fuel precursor consists essentially of nitrogen, hydrogen, and optionally oxygen and/or carbonate and/or carbonic acid derivatives and/or fully oxidized carbon.

In further embodiments of the system and method for generation of supercritical fluid, the at least one additional substance introduced is introduced as liquid. In some embodiments, the liquid additional substance comprises water.

In further embodiments of the system and method for generation of supercritical fluid, the at least one additional substance introduced is introduced as gas. In some embodiments, the at least one additional substance is low-temperature steam.

In some embodiments, the fuel or fuel precursor, the oxidizing agent, or both the fuel or fuel precursor and the oxidizing agent used in the system are, or can be, in an aqueous solution prior to introduction into the reaction chamber. In some embodiments, the fuel or fuel precursor and oxidizing agent are, or can be, introduced and reacted in fluid form, in liquid form such as in an aqueous solution, in gaseous form, in steam, or in supercritical steam (supercritical water), in solid form, including solids in suspensions in fluid, such as a solid in suspension in liquid or in gas, or in any combination of the foregoing. The fuel or fuel precursor and oxidizing agent react in the reaction chamber to release energy. In some embodiments, the fuel or fuel precursor and oxidizing agent are, or can be, introduced and reacted in an aqueous solution or in steam. In one embodiment, the energy released is, or can be, released as heat. In another embodiment, the energy released is, or can be, released as pressure and/or volume change. In another embodiment, the energy released is, or can be, released as pressure and/or volume change, and as heat. The energy released can be used to heat liquid water to form steam. The energy released can be used to heat liquid water to supercritical steam (supercritical water). The energy released can be used to increase the pressure of a substance, such as a fluid or working fluid, such as a gas or liquid. The energy released can be used to do work.

In other embodiments, the fuel is, or can be, selected from the group consisting of ammonia, ammonia gas, anhydrous ammonia, ammonium hydroxide, ammonium nitrate, ammonium perchlorate, hydroxylamine, hydrazine, ammonium bicarbonate, and ammonium carbonate. In further embodiments, the fuel is, or can be, ammonia or ammonium hydroxide.

In other embodiments, the fuel precursor can be urea.

In other embodiments, the oxidizing agent is, or can be, selected from the group consisting of hydrogen peroxide, nitric acid, nitrous oxide, nitric oxide, nitrogen dioxide, nitrogen tetroxide, and sodium percarbonate. In further embodiments, the oxidizing agent is, or can be, hydrogen peroxide.

In another embodiment, the fuel is, or can be, ammonia or ammonium hydroxide, and the oxidizing agent is, or can be, hydrogen peroxide.

In another embodiment, the fuel precursor is, or can be, urea, and the oxidizing agent is, or can be, hydrogen peroxide.

In some embodiments, the fuel can be a low-carbon fuel.

In other embodiments, the reaction chamber comprises or contains a catalyst or catalysts. The one or more catalysts are, or can be, a main group metal, a main group metal oxide, a transition metal, a transition metal oxide, a heavy metal, a heavy metal oxide, a zinc triad element or zinc triad element oxide; a nickel triad metal or nickel triad metal oxide; a platinum group metal or platinum group metal oxide; a lanthanide or lanthanide oxide; an actinide or actinide oxide; or their alloys; or combinations of any or all of the foregoing. The one or more catalysts are, or can be, catalysts for the decomposition of the oxidizing agent, the decomposition of the fuel or fuel precursor, or the decomposition of both the oxidizing agent and the fuel or fuel precursor. The catalyst(s) is, or can be, a catalyst for the decomposition of hydrogen peroxide, including metallic or metal oxide forms of: main group elements Li, Na, K, Rb, Cs, Be, Mg, Ca, Sr, Ba, B, Al, Ga, In, Si, Ge, Sn, P, Sb, S, and Zn; transition elements Sc, Y, Ti, Zr, Hf; V, Nb, Ta, Cr, Mo, W, Mn, Re, Fe, Ru, Os, Co, Rh, Ir, Ni, Pd, Pt, Cu, Ag, and Au; the lanthanide elements; and actinium; or their alloys; or combinations of any or all of the foregoing. The catalyst(s) is, or can be, a catalyst or catalysts for the decomposition of NH₃ or NH₄OH. In some embodiments, the reaction chamber comprises at least one catalyst for the decomposition of hydrogen peroxide and at least one catalyst for the decomposition of NH₃ or NH₄OH. In some embodiments, the reaction chamber comprises at least one catalyst for the decomposition of hydrogen peroxide and at least one catalyst for the decomposition of urea. In some embodiments, the reaction chamber comprises at least one catalyst for the decomposition of hydrogen peroxide, at least one catalyst for the decomposition of urea, and at least one catalyst for the decomposition of NH₃ or NH₄OH.

In one embodiment, the invention embraces a system for generation of energy, said system comprising a fuel precursor which can be decomposed into a fuel with a molecular formula comprising nitrogen; an oxidizing agent; and a reaction chamber into which the fuel precursor and oxidizing agent can be introduced; in which the fuel precursor can be decomposed into fuel with a molecular formula comprising nitrogen, and the fuel and oxidizing agent can react in fluid form, in liquid form such as in an aqueous solution, in gaseous form, in steam, or in supercritical steam (supercritical water), in solid form, including solids in suspensions in fluid, such as a solid in suspension in liquid or in gas, or in any combination of the foregoing. In some embodiments, the fuel precursor, the oxidizing agent, or both the fuel precursor and the oxidizing agent used in the system are, or can be, in an aqueous solution prior to introduction into the reaction chamber. The fuel and oxidizing agent can react in the reaction chamber to release energy. In one embodiment, the energy released is, or can be, released as heat. In another embodiment, the energy released is, or can be, released as pressure and/or volume change. In another embodiment, the energy released is, or can be, released as pressure and/or volume change, and as heat. The energy released can be used to heat liquid water to form steam. The energy released can be used to heat liquid water to supercritical steam (supercritical water). The energy released can be used to increase the pressure of a substance, such as a fluid or working fluid, such as a gas or liquid. The energy released can be used to do work.

In other embodiments, the fuel precursor is, or can be, urea, and the fuel is ammonia. In other embodiments, the fuel precursor is, or can be, urea, and the fuel is ammonium hydroxide.

In other embodiments, the oxidizing agent is, or can be, selected from the group consisting of hydrogen peroxide, nitric acid, nitrous oxide, nitric oxide, nitrogen dioxide, nitrogen tetroxide, and sodium percarbonate. In further embodiments, the oxidizing agent is, or can be, hydrogen peroxide.

In another embodiment, the fuel precursor is urea and the oxidizing agent is, or can be, hydrogen peroxide.

In some embodiments, the fuel can be a low-carbon fuel.

In other embodiments, the reaction chamber comprises or contains a catalyst or catalysts. The one or more catalysts are, or can be, a main group metal, a main group metal oxide, a transition metal, a transition metal oxide, a heavy metal, a heavy metal oxide, a zinc triad element or zinc triad element oxide; a nickel triad metal or nickel triad metal oxide; a platinum group metal or platinum group metal oxide; a lanthanide or lanthanide oxide; an actinide or actinide oxide; or their alloys; or combinations of any or all of the foregoing. The one or more catalysts are, or can be, catalysts for the decomposition of the oxidizing agent, the decomposition of the fuel or fuel precursor, or the decomposition of both the oxidizing agent and the fuel or fuel precursor. The catalyst(s) is, or can be, a catalyst for the decomposition of hydrogen peroxide, including metallic or metal oxide forms of: main group elements Li, Na, K, Rb, Cs, Be, Mg, Ca, Sr, Ba, B, Al, Ga, In, Si, Ge, Sn, P, Sb, S, and Zn; transition elements Sc, Y, Ti, Zr, Hf; V, Nb, Ta, Cr, Mo, W, Mn, Re, Fe, Ru, Os, Co, Rh, Ir, Ni, Pd, Pt, Cu, Ag, and Au; the lanthanide elements; and actinium; or their alloys; or combinations of any or all of the foregoing. The catalyst(s) is, or can be, a catalyst or catalysts for the decomposition of urea. The catalyst(s) is, or can be, a catalyst or catalysts for the decomposition of NH₃ or NH₄OH. In some embodiments, the reaction chamber comprises at least one catalyst for the decomposition of hydrogen peroxide and at least one catalyst for the decomposition of NH₃ or NH₄OH. In some embodiments, the reaction chamber comprises at least one catalyst for the decomposition of hydrogen peroxide and at least one catalyst for the decomposition of urea. In some embodiments, the reaction chamber comprises at least one catalyst for the decomposition of urea and at least one catalyst for the decomposition of NH₃ or NH₄OH. In some embodiments, the reaction chamber comprises at least one catalyst for the decomposition of urea, at least one catalyst for the decomposition of hydrogen peroxide, and at least one catalyst for the decomposition of NH₃ or NH₄OH.

In any of the embodiments recited above, homogeneous, heterogeneous, or slurry phase catalysts, or a mixture of types of catalyst, can be used. The catalyst can be any one or more of the following: main group metals, main group metal oxides; heavy metals; heavy metal oxides; transition metal-based catalysts; transition metal oxides; lanthanide metals; lanthanide metal oxides; actinium, actinium oxide; or combination of any or all of the foregoing. In particular, the catalyst(s) is, or can be, a catalyst including metallic or metal oxide forms of: main group elements Li, Na, K, Rb, Cs, Be, Mg, Ca, Sr, Ba, B, Al, Ga, In, Si, Ge, Sn, P, Sb, S, and Zn; transition elements Sc, Y, Ti, Zr, Hf; V, Nb, Ta, Cr, Mo, W, Mn, Re, Fe, Ru, Os, Co, Rh, Ir, Ni, Pd, Pt, Cu, Ag, and Au; the lanthanide elements; and actinium; or their alloys; or combination of any or all of the foregoing. Preferably the catalyst(s) are selected from iron and iron-based catalysts including ferrite, Fenton's reagent, Fe (II)-containing compounds, iron (II) sulfate; chromium-based catalysts including chromic acid, dichromate; compounds of the form MFe₂O₄ and MCo₂O₄ where M is selected from the group consisting of Mn, Fe, Co, Ni, Zn, and Mg; manganese and manganese-based catalysts including MnO₂, MnO, and KMnO₄; molybdenum-based catalysts including Mo and MoO₃; tungsten-based catalysts including W and WO₃; copper-based catalysts including Cu, copper oxide, and copper (II) sulfate; Ni, Pd, Pt, Ag, Au, Zn and their oxides; lanthanide M₂O₃-type metal oxides including those of Ce and La; boria; aluminum-based catalysts including alumina; aluminosilicates; zeolites; titanium; titanium-based catalysts; Ti(III)-containing compounds; Ti(IV)-containing compounds; titanium oxides including rutile, anatase, brookite, and amorphous forms of titania; zirconium and zirconia; titania-tungsten mixtures; vanadium, niobium, tantalum and their oxides; ruthenium, iridium, osmium, and rhodium, or oxides thereof; silicon dioxide; quartz; borosilicate glass; magnesium oxide; calcium oxide; protein catalysts; catalase; or any combination thereof. The catalysts are, or can be, supported on an inert matrix. They can be in the form of beads, particles, wire screens, meshes, sponges, metallic sponges, ceramic sponges, or microtubules.

In any of the embodiments recited above, a high-voltage arc, a spark plug, high-energy radiation, a laser, or radiofrequency energy, or any combination thereof, can be used to initiate or accelerate the chemical reaction in the reaction chamber.

Some embodiments described herein are recited as “comprising” or “comprises” with respect to their various elements. In alternative embodiments, those elements can be recited with the transitional phrase “consisting essentially of” or “consists essentially of” as applied to those elements. In further alternative embodiments, those elements can be recited with the transitional phrase “consisting of” or “consists of” as applied to those elements. Thus, for example, if a composition or method is disclosed herein as comprising A and B, the alternative embodiment for that composition or method of “consisting essentially of A and B” and the alternative embodiment for that composition or method of “consisting of A and B” are also considered to have been disclosed herein. Likewise, embodiments recited as “consisting essentially of” or “consisting of” with respect to their various elements can also be recited as “comprising” as applied to those elements. Finally, embodiments recited as “consisting essentially of” with respect to their various elements can also be recited as “consisting of” as applied to those elements, and embodiments recited as “consisting of” with respect to their various elements can also be recited as “consisting essentially of” as applied to those elements.

The systems and methods described herein, including any embodiment of the invention as described herein, may be used alone or may be used in combination with other systems and methods.

### BRIEF DESCRIPTION OF THE DRAWINGS

FIG. 1 shows a block diagram of the fuel process for one embodiment of the invention, using aqueous H₂O₂ and aqueous NH₃.

FIG. 2 depicts the expansion ratio of the decomposition of hydrogen peroxide under isothermal and adiabatic conditions.

FIG. 3A and FIG. 3B depict one embodiment of a reaction chamber suitable for reaction of the fuel and oxidizing agents according to the invention.

FIG. 4A, FIG. 4B, and FIG. 4C depict another embodiment of a reaction chamber suitable for reaction of the fuel and oxidizing agents according to the invention.

FIG. 5A and FIG. 5B depict another embodiment of a reaction chamber suitable for reaction of the fuel and oxidizing agents according to the invention.

### MODES FOR CARRYING OUT THE INVENTION

The invention provides fuels which have the desirable characteristics of hydrogen, while avoiding the disadvantages of using molecular hydrogen (H₂), and provides systems for using such fuels in conjunction with an oxidizing agent. The invention is based upon the use of chemical hydrogen carriers such as ammonia, ammonia gas, hydroxylamine, hydrazine, and other compounds, which either do not contain carbon, or contain carbon only in a fully oxidized form or in a non-oxidizable form, or which do not contain oxidizable carbon to any significant extent. The use of fuels with molecular formulas comprising nitrogen and hydrogen aids in production of relatively inert combustion products, such as N₂ and H₂O. Such fuels avoid or minimize the generation of greenhouse gases such as CO₂.

Another advantage of the present invention is that the fuels can be stored in either solid, liquid, solution, or gaseous form, providing flexibility in storage and transportation of the fuel.

Yet another advantage of the present invention is that the fuels can be utilized in aqueous solution. Water is a convenient, ubiquitous, and environmentally sound solvent. Water absorbs the energy of the chemical reaction, and turns it into potential steam pressure.

The invention uses a fuel with a molecular formula which contains hydrogen, and an oxidizing agent. The fuel and the oxidizing agent are reacted to produce energy in the form of heat, which can then be used in a variety of applications, including, but not limited to, supplying power in an automobile engine, supplying hot fluid for heating systems, or generation of electricity. Electricity can be generated by the use of a steam turbine or other methods known to those of skill in the art.

In any of the embodiments of the invention recited herein, the invention can exclude a reaction engine or rocket engine. A reaction engine is an engine that develops thrust primarily by expelling mass, such as a jet of fluid, a stream of particles, or any combination thereof.

The systems and methods described herein are intended and designed for the principal purpose of producing and harnessing useful and productive energy, which is utilized for purposes including, but not limited to, production of electricity, mechanical work such as propulsion of vehicles (but excluding reaction engines such as rocket engines), or to heat defined spaces such as buildings, vehicles, ovens, or large storage tanks.

### EXEMPLARY EMBODIMENTS OF THE INVENTION

To illustrate the principles of the invention, an example using ammonia (NH₃) and hydrogen peroxide (H₂O₂) is provided. Ammonia and hydrogen peroxide react as follows:

2NH₃(g)+3H₂O₂(g) [symbol] 6H₂O(g)+N₂(g)(ΔH°=−158.3 kJ/mol water) (Equation 2)

The individual reactions may be described as follows:

H₂O₂ [symbol] H₂O+0.5O₂(ΔH°=−105.5 kJ/mol water) (Equation 1);

2NH₃ [symbol] N₂+3H₂(ΔH°=46.1 kJ/mol NH₃) (Equation 3);

and

H₂+0.5O₂ [symbol] H₂O(ΔH°=−241.8 kJ/mol) (Equation 4).

The overall reaction is exothermic, with the production of water, nitrogen, and heat as indicated in Equation 2.

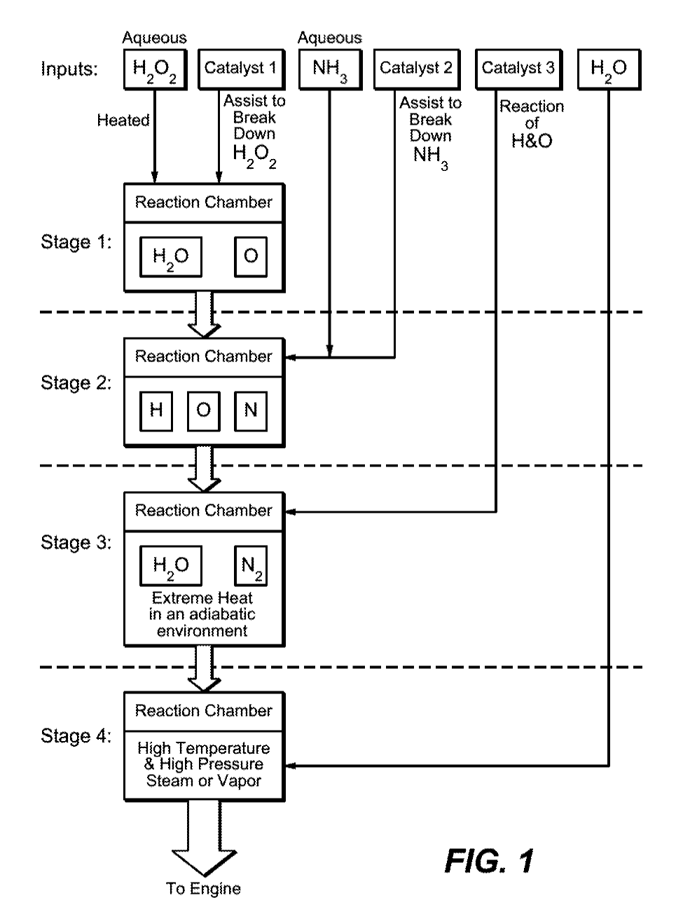

FIG. 1 provides an overview of one embodiment of the fuel process, showing the reactions as separate steps, where the reaction of Equation 1 is depicted in Stage 1, the reaction of Equation 3 is depicted in Stage 2 (which also shows the oxygen from Stage 1, but which omits the water from stage 1), and the final products, H₂O and N₂, of Equation 2 are depicted in Stage 3. Stages 1, 2, and 3 combined thus show the overall reaction of Equation 2. It should be understood that the separation and depiction of steps in FIG. 1 are not necessarily reflective of the actual chemical species present (for example, isolated atomic hydrogen, atomic nitrogen, or atomic oxygen may not be present or, if present, may not be dominant species, and other chemical species may be present as intermediates or side products). It should also be understood that the separation and depiction of steps in FIG. 1 are not necessarily reflective of the actual sequence of chemical steps, or of the actual sequence of introduction of fuel(s) and/or oxidizing agent(s), nor is the indication of addition of reagents and catalysts in FIG. 1 necessarily indicative of the order in which they are added in the invention, or whether they are added versus being present during the entire reaction (for example, the catalysts may be added at various stages into the reaction chamber, or can be continuously present in the reaction chamber, or can be introduced and withdrawn from the reaction chamber at specified times). The illustration in FIG. 1 is intended to aid in the understanding of the overall process, and not to limit the invention in any manner. The reaction can proceed in batch mode or continuous mode, and consequently the stages can be repeated as desired; also, the stages may overlap substantially or completely in temporal sequence, or occur in a different order from that depicted when chemically possible. However, since the energy released in the reaction of Equation 2 is a thermodynamic function of state, the amount of energy released in the reaction of Equation 2 is independent of the specific path taken from the initial reagents to the final products of the reaction.

In Stage 1, H₂O₂ is introduced, breaking down into water and oxygen. The rate of breakdown is enhanced by catalysts or other rate enhancers.

In Stage 2, NH₃ is introduced, for stepwise breakdown.

In Stage 3, NH₃ has reacted with the oxygen-containing species produced by the breakdown of H₂O₂, to produce water and an environmentally benign gas (N₂).

In stage 4, the energy from both the hydrogen peroxide decomposition and the ammonia reaction generates significant amounts of heat and steam. Additional liquid water can be introduced at any stage in the process to generate additional steam. The resulting low-pressure, medium-pressure, or high-pressure steam can be used to power a mechanical device, such as an engine, or for use in heating for industrial or residential purposes.

### Tunability of the Fuel/Oxidizing Agent Reaction

Equation 2 is written in stoichiometric balance. However, in some embodiments, sub-stoichiometric amounts of NH₃ (that is, the fuel) can be used, or equivalently, excess oxidizing agent can be used. The reaction can thereby be “tuned” further to alter the amount of heat and the products produced. Use of sub-stoichiometric amounts of fuel (such as NH₃), or equivalently, use of excess oxidizing agent, may result in excess oxidizing agent (such as H₂O₂) over the amount needed to drive the reaction of Equation 2 to completion. The excess H₂O₂ can then decompose according to Equation 1. Because Equation 1 is an exothermic reaction, such decomposition produces heat, and will also result in some amount of O₂ released along with the N₂ and water formed in the reaction of Equation 2. By changing the quantity, concentration, or volume of oxidizing agent (such as H₂O₂) used, the energy and amount of oxygen released can be shifted between that produced by the reaction of Equation 2 and that produced by the reaction of Equation 1, in order to accommodate various capacities and operating conditions (for example, temperature, pressure) of the specific use and design embodiment (for example, engine, heating, etc.). The tunability can be further enhanced by use of catalysts for equations (1), (2), and/or (3), to provide selective conversion and enhanced control over reaction rate.

### Fuels

Fuels for use in the invention include compounds which can provide hydrogen for oxidation. Currently, the majority of energy production worldwide relies on non-renewable fossil fuel resources. Carbon serves as the hydrogen carrier in fossil fuels, and carbon is also oxidized during energy production from hydrocarbon fuels. The CO₂ emitted contributes to the greenhouse effect, and contributes to acidification of water supplies when CO₂ is absorbed by surface water to produce carbonic acid. The invention enables the generation of power without significant production of carbon dioxide, or, in certain embodiments, uses carbon dioxide or carbon dioxide equivalents only as a carrier, utilizing chemicals such as carbonates or carbonic acid derivatives, so that no net carbon dioxide is generated.

Exemplary fuels for use in the invention include ammonia, such as ammonia gas or anhydrous ammonia, or aqueous ammonia (ammonium hydroxide); hydroxylamine, hydrazine; ammonium carbonate; and ammonium bicarbonate. The fuels can be used in solid, fluid, liquid, solution, or gaseous form. The liquid form of the fuels can be supplied as an aqueous solution, which provides significant advantages in storage and handling.

In one embodiment, ammonia (NH₃) is used as the fuel. Ammonia is widely used in fertilizers, cleaners, antimicrobials, and a wide variety of pharmaceutical and industrial processes. At standard temperature and pressure, NH₃ is a colorless gas with a distinctive pungent odor; humans can detect ammonia at concentrations as low as 53 ppm. Ammonia is often used as an aqueous solution, as ammonium hydroxide. Ammonia can be produced from a wide variety of sources, from camel dung to coal, and most famously by using the Haber-Bosch process for which Fritz Haber was awarded the 1918 Nobel Prize in Chemistry. Energy is required for the process.

NH₃ can be decomposed via its nitrogen and hydrogen components. This decomposition can be facilitated through use of one or more catalysts. The incipient production of hydrogen can be coupled with oxidation of H-containing species, via an oxidizing agent, to provide energy. Ammonia thus can act as a hydrogen carrier—a molecule that can be used to effectively supply hydrogen for a reaction, without the disadvantages of transporting or storing H₂ gas (or liquid H₂). In one embodiment, the NH₃ is stored as an aqueous solution (that is, as ammonium hydroxide in water) prior to use. In another embodiment, the NH₃ is stored as liquid NH₃ prior to use. In another embodiment, the NH₃ is stored as a compressed gas. In another embodiment, the NH₃ is stored as a salt, and regenerated as NH₃ immediately prior to use. For example, NH₄Cl (which can be prepared from NH₃ and HCl) can be treated with NaOH to yield NH₃, H₂O, and NaCl; the ammonia released can be used as fuel in the invention. Ammonium bicarbonate (NH₄HCO₃) and ammonium carbonate ((NH₄)₂CO₃) can also be used; these compounds decompose to ammonia, water, and carbon dioxide when heated.

In the embodiments that use carbonates or carbonic acid derivatives, such as ammonium bicarbonate and ammonium carbonate, the carbon used is in its fully oxidized form; that is, the carbon cannot be oxidized further (the carbon is non-oxidizable). While use of these fuels releases the greenhouse gas carbon dioxide, this release can be offset by the earlier sequestration of the carbon dioxide during preparation of the ammonium carbonate or ammonium bicarbonate, so no net CO₂ would be added to the atmosphere. Thus, in one embodiment, the molecular formula of the fuel used in the invention can comprise nitrogen and hydrogen, while essentially excluding any forms of carbon which are not already fully oxidized and/or essentially excluding oxidizable carbon and/or when carbon is present in the fuel, essentially including only non-oxidizable carbon; these conditions on the carbon content of the fuel excludes compounds such as alkanes, alkenes, and related fuels such as alkanols from the fuels in any significant amounts. Forms of carbon which are not yet already fully oxidized include compounds such as alkanes, alkenes, and related fuels such as alkanols; thus, a fuel essentially excluding any forms of carbon which are not already fully oxidized will exclude significant amounts of compounds such as alkanes, alkenes, and related fuels such as alkanols. In contrast, fully-oxidized carbon includes carbon dioxide and derivatives such as carbonic acid (H₂CO₃), carbonic acid derivatives such as urea, bicarbonates (such as NaHCO₃, KHCO₃, NH₄HCO₃, etc.) and carbonates (such as Na₂CO₃, K₂CO₃, (NH₄)₂CO₃, etc.). A fuel “essentially excluding” carbon not already fully oxidized contains less than about 5%, less than about 4%, less than about 3%, less than about 2%, less than about 1%, less than about 0.5%, less than about 0.1%, less than about 0.05%, or less than about 0.01% of a carbon-based fuel containing carbon not already fully oxidized, on either a weight, volume, mole percent, or energy percent basis, where energy percent is the percent of energy ultimately derived from a given molecular species in the fuel. The amount of fuel derivable from a fuel precursor is used to calculate percentages for a fuel precursor essentially excluding carbon. An example of such a fuel essentially excluding carbon not already fully oxidized is a fuel mixture comprising 96% by weight of ammonia and 4% by weight of gasoline, ethanol, diesel fuel, or other similar fuel. An example of a fuel precursor essentially excluding carbon not already fully oxidized is a fuel precursor having sufficient urea to provide a fuel mixture comprising 96% by weight of ammonia and 4% by weight of gasoline, ethanol, diesel fuel, or other similar fuel.

In some embodiments, a low-carbon fuel can be used. A low carbon fuel contains about 5% to about 25%, about 5% to about 20%, about 5% to about 15%, or about 5% to about 10% of a carbon-based fuel containing carbon not already fully oxidized, on either a weight, volume, mole percent, or energy percent basis, where energy percent is the percent of energy ultimately derived from a given molecular species in the fuel. A low-carbon fuel precursor is a fuel precursor mixed with a carbon-based fuel containing carbon not already fully oxidized in proportions to yield the foregoing percentages recited for low-carbon fuel.

With respect to the molecular formulation of the fuels, in one embodiment, the molecular formula of the fuel comprises nitrogen and hydrogen. In another embodiment, the fuel (that is, the molecular formula of the fuel) used can comprise nitrogen, hydrogen, and optionally oxygen and/or carbonate or carbonic acid derivatives and/or fully oxidized carbon. In another embodiment, the molecular formula of the fuel used can comprise nitrogen, hydrogen, and optionally oxygen and/or carbonate and/or carbonic acid derivatives and/or fully oxidized carbon, essentially excluding carbon not already fully oxidized and/or essentially excluding oxidizable carbon and/or when carbon is present in the fuel, essentially including only non-oxidizable carbon. In another embodiment, the molecular formula of the fuel can consist essentially of nitrogen, hydrogen, and optionally oxygen and/or carbonate and/or carbonic acid derivatives and/or fully oxidized carbon. In another embodiment, the molecular formula of the fuel can consist essentially of nitrogen, hydrogen, and optionally oxygen and/or carbonate and/or carbonic acid derivatives and/or fully oxidized carbon, essentially excluding carbon not already fully oxidized and/or essentially excluding oxidizable carbon and/or when carbon is present in the fuel, essentially including only non-oxidizable carbon.

The term “fuel” is also intended to embrace mixtures of individual molecular or chemical species. For example, the term fuel can embrace a mixture of 50% ammonia and 50% hydrazine, or mixtures of two, three, or more individual chemical compounds in any proportion. The molecular formulations described above would then apply to all components of the fuel taken together; that is, a fuel indicated as having a molecular formula comprising nitrogen, hydrogen, and oxygen could be comprised of NH₃ and N₂O, as each component of a multi-component fuel need not have the specified molecular formulation, as long as the mixture of components contains the elements specified.

Fuels can be used as solid, fluid, liquid, or gaseous solutions (when one chemical compound is present as the fuel) or as solid, fluid, liquid, or gaseous solutions or mixtures (when two or more chemical compounds are present as the fuel), or as any combination of the foregoing. The fuels can be combined with a carrier or matrix, such as water.

### Fuel Precursors

Substances which break down to fuels, that is, fuel precursors, can also be used in the invention. When a fuel precursor and an oxidizing agent are indicating as “reacting,” it refers to the breakdown or conversion of the fuel precursor to fuel, which fuel then reacts with the oxidizing agent.

An example of a fuel precursor is urea, H₂N—C(═O)—NH₂. Urea solutions are often employed for storage of ammonia, with the urea being converted to ammonia just before use or during use. It should be noted that the oxidation state of the carbon atom in urea is +4, and thus the carbon in urea is fully oxidized.

### Oxidizing Agents

Exemplary oxidizing agents for use in the invention include hydrogen peroxide, nitric acid, nitrous oxide, nitric oxide, nitrogen dioxide, nitrogen tetroxide, and sodium percarbonate. Gaseous oxygen, gaseous air, liquid oxygen, and liquid air can also be used. Oxidizing agents can be used in solid, fluid, liquid, solution, or gaseous form.

In one embodiment of the invention, hydrogen peroxide (H₂O₂) is used as the oxidizing agent. Hydrogen peroxide is widely used as a bleaching agent and disinfectant, and has been used in high concentrations as a rocket propellant. Hydrogen peroxide has been used as a monofuel in an engine (see, for example, US 2009/0050080). H₂O₂ is a colorless to pale blue liquid, and is colorless in dilute aqueous solution. It is slightly more viscous than water (about 1.25 cP versus 1.00 for water), and is a very weak acid (pKa=11.6). H₂O₂ decomposes to water and oxygen in a disproportionation reaction. Both the rate of formation of hydrogen peroxide from water and its decomposition can be facilitated by light. Decomposition of hydrogen peroxide can be effected thermally. Numerous catalysts, including, but not limited to, transition metals and their oxides, can also accelerate hydrogen peroxide decomposition.

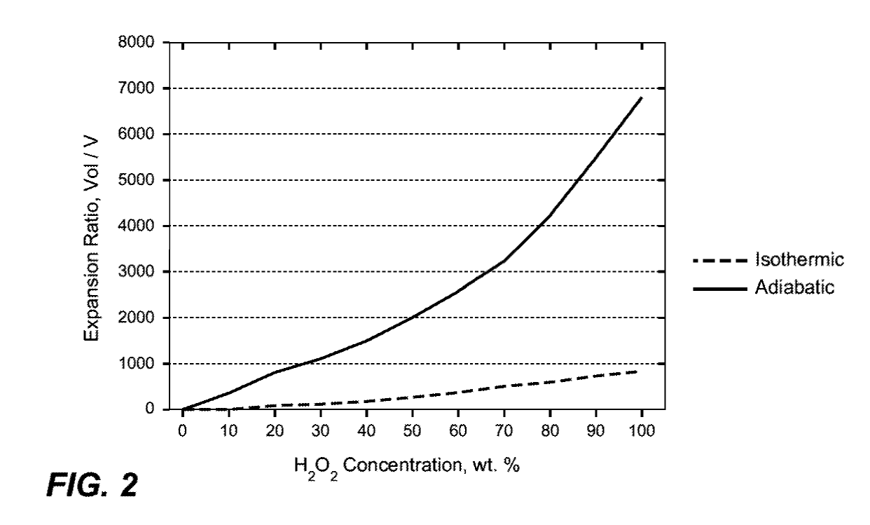

The expansion of volume upon decomposition of H₂O₂ in an adiabatic environment is remarkable, as show in FIG. 2 (the upper curve indicates adiabatic conditions, where no heat is exchanged with the surroundings; the lower curve indicates isothermal conditions, i.e. reaction at constant temperature). For example, using a 70% concentration of H₂O₂, a single unit of pre-heated liquid can generate 2700 units of resultant gas within an adiabatic environment. Decomposition of a 64% concentration of H₂O₂ evolves sufficient heat to vaporize all of the water created during the decomposition of hydrogen peroxide to water and oxygen.

Decomposition of 70% H₂O₂ produces about 480 cal/gm of heat energy. When contained within the adiabatic environment, this heat would be available to maintain a constant temperature, at or above about 235° C.

The term “oxidizing agent” is also intended to embrace mixtures of individual molecular or chemical species, in any proportion.

Oxidizing agents can be used as solid, fluid, liquid, or gaseous solutions (when one chemical compound is present as the oxidizing agent), or as solid, fluid, liquid, or gaseous solutions or mixtures (when two or more chemical compounds are present as the oxidizing agent). Oxidizing agents can be combined with a carrier or matrix, such as water.

### Reservoirs for Fuel or Oxidizer Storage

In one embodiment, the fuel and the oxidizing agent to be used are maintained until use, in solid, solution, fluid, liquid, or gaseous form, in separate storage units, referred to herein as a reservoir regardless of whether the fuel and/or oxidizer is in solid, solution, fluid, liquid, or gaseous form. The reservoirs can be constructed from any material suitable for storage of the chemical components. In one embodiment, the temperature of the fuel is maintained at ambient temperature. In one embodiment, the temperature of the oxidizing agent is maintained at ambient temperature. In one embodiment, the temperature of the fuel and the temperature of the oxidizing agent are maintained at ambient temperature. In another embodiment, the reservoirs are temperature controlled. In another embodiment, the temperature of the fuel is maintained at 25° C. In another embodiment, the fuel is maintained at a temperature above ambient temperature. In another embodiment, the temperature of the fuel is maintained at a temperature above its freezing point but below its boiling point, that is, the temperature of the fuel is maintained at a temperature such that the fuel is a liquid. In one embodiment, the temperature of the oxidizing agent is maintained at 25° C. In another embodiment, the oxidizing agent is maintained at a temperature above ambient temperature. For example, high purity solutions of H₂O₂ can be maintained at up to 110° C. when stored in materials compatible with hydrogen peroxide. In another embodiment, the temperature of the oxidizing agent is maintained at a temperature above its freezing point but below its boiling point, that is, the temperature of the oxidizing agent is maintained at a temperature such that the oxidizing agent is a liquid.

In another embodiment, the fuel and the oxidizing agent can be stored in the same reservoir, in solid, fluid, liquid, solution, or gaseous form. This embodiment relies on fuels and oxidizing agents that are relatively inert when mixed together at low temperatures and/or relatively inert when mixed together in the absence of a catalyst, which avoids undesired reaction and loss of energy prior to introduction into the reaction chamber.

The embodiments described above for combinations of a fuel and an oxidizing agent can also be employed for combinations of a fuel precursor and an oxidizing agent.

### Fuel/Oxidizer Combinations; Kits

Using H₂O₂ solution alone requires a high concentration to produce the heat and pressure required for practical energy uses. Inclusion of a hydrogen-containing fuel, such as ammonia (NH₃), with the H₂O₂ (or alternative oxidizing agents) provides a substantial increase over the energy provided by the decomposition of H₂O₂. This generates additional energy for volatilizing water and allows the use of a lower percentage of H₂O₂ to achieve the same amount of work. Importantly, by using, for example, a combination of H₂O₂ and NH₃ in the fuel mixture, the concentration of both reactants can be reduced while still creating the increased temperature and pressure reaction required for practical applications. In the embodiment of the invention using H₂O₂ and NH₃, the concentration levels of the reactants can be used in concentrations similar to those encountered in commercial industries such as food sanitation. This in turn simplifies any transportation, storage and handling requirements for these fuel components.

The invention embraces fuel/oxidizer combinations suitable for generation of energy. Such combinations include ammonia and hydrogen peroxide, ammonium hydroxide and hydrogen peroxide, hydroxylamine and hydrogen peroxide, and hydrazine and hydrogen peroxide. “Fuel/oxidizer combinations” is used to indicate a pairing of a fuel with an oxidizer during reaction; “combination” does not necessarily imply that the fuel and oxidizer are mixed together prior to introduction into the reaction chamber, although in certain embodiments, the fuel and oxidizer can be mixed together prior to introduction into the reaction chamber, or in some embodiments, the fuel and oxidizer can be mixed together for transportation and/or storage.

In one embodiment, the invention embraces a kit comprising a first reservoir of a fuel having a molecular formula comprising nitrogen and hydrogen, said fuel essentially excluding carbon not already fully oxidized and/or essentially excluding oxidizable carbon and/or when carbon is present in the fuel, essentially including only non-oxidizable carbon; a second reservoir comprising an oxidizing agent; and instructions for combination of the fuel and oxidizing agent to produce energy. In another embodiment, the invention embraces a kit comprising a first reservoir of a fuel having a molecular formula consisting essentially of nitrogen, hydrogen, and optionally oxygen and/or carbonate and/or carbonic acid derivatives and/or fully oxidized carbon; a second reservoir comprising an oxidizing agent; and instructions for combination of the fuel and oxidizing agent to produce energy. In another embodiment, the invention embraces a kit comprising a first reservoir of ammonia or ammonium hydroxide; a second reservoir comprising an oxidizing agent; and instructions for combination of the fuel and oxidizing agent to produce energy.

The embodiments described above for combinations of a fuel and an oxidizing agent can also be employed for combinations of a fuel precursor and an oxidizing agent.

### Single-Chemical Fuel/Oxidizing Agent Combinations

In some embodiments, the fuel and the oxidizing agent are present in a single chemical. An example of such a fuel is ammonium nitrate, NH₄NO₃, which combines the strong oxidizing agent nitrate with the hydrogen source ammonium. Ammonium nitrate can decompose either into nitrous oxide and water:

NH₄NO₃ [symbol] N₂O+2H₂O

or into nitrogen, water, and oxygen:

NH₄NO₃ [symbol] N₂+2H₂O+½O₂.

Both reactions are exothermic. Ammonium nitrate can be used as an effective fuel, if its highly explosive nature is managed appropriately.

### Reaction Chamber

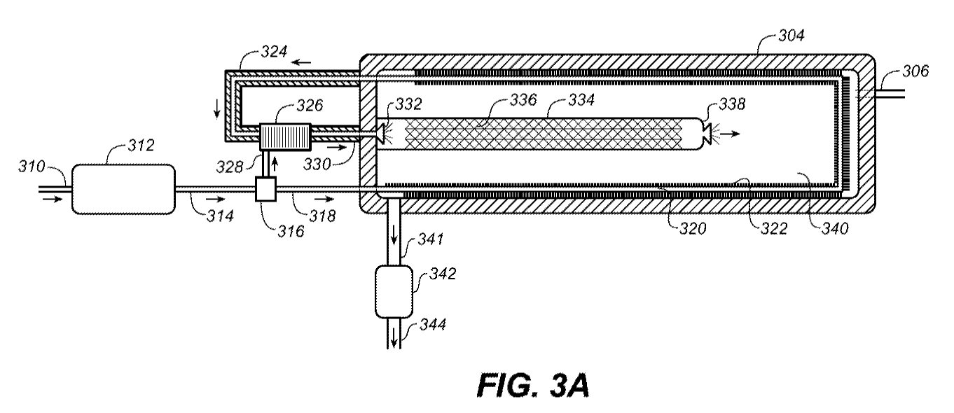

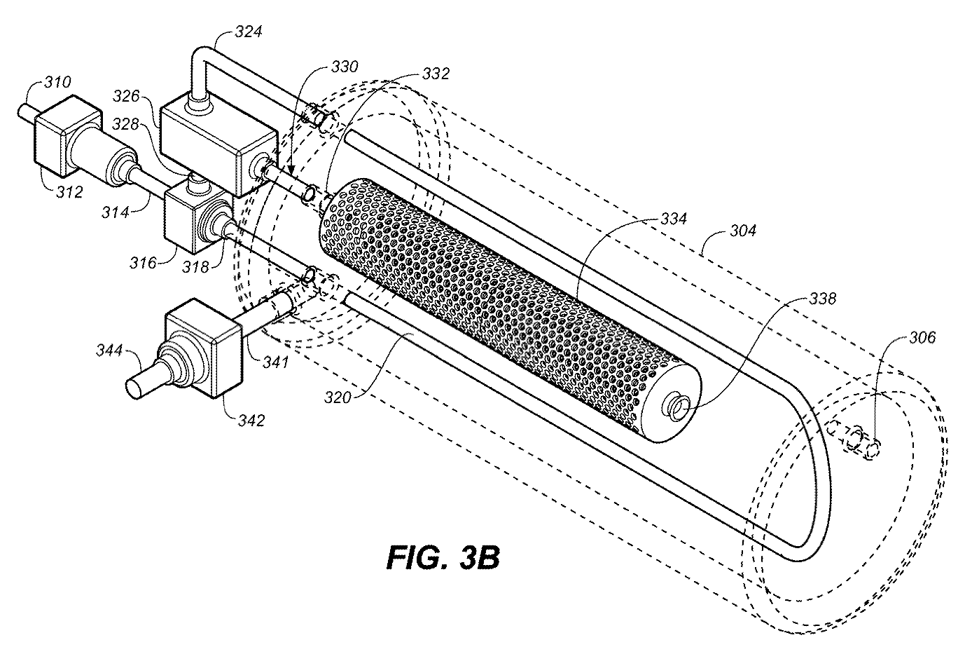

The fuel and oxidizing agent are introduced into a reaction chamber designed to accommodate the heat and pressure generated by the reaction. One embodiment of such a reaction chamber (304) is shown in FIG. 3A (in two-dimensional layout) and in FIG. 3B (in a three-dimensional representation), depicting a catalyst bed and pressure chamber for use in the production and control of high-pressure, high-temperature vapor according to the invention. The size, shape, configuration, and components (including materials of construction and catalytic agents) can be varied to reflect the desired quantity and temperature of the resultant products and the chemical or chemicals used as fuel, oxidizing agent, and other components such as liquid carriers.

A mixture comprising fuel and oxidizing agent, along with diluting carrier liquids such as water, is provided via feed tube (310) to a high pressure chemical pump (312). The mixture is then pressurized to the desired pressure (depending on application and performance requirements) and transported via a high-pressure tube (314) to a directional valve (316).

If the engine has not yet reached operating temperature (such as during initial start-up, or after extended idle periods) the fuel/oxidizer mixture is directed via high-pressure tube (328) to an electric pre-heater (326) to be heated to the desired temperature for reaction. The heated mixture is then introduced via injector (332) into a catalytic chamber (334) filled with a catalytic matrix (336) composed of an appropriate catalyst or catalyst blend.

The reaction of the fuel and oxidizer is catalyzed by the catalyst bed, resulting in an exothermic reaction(s) which maintains the catalyst and reaction chamber at the desired temperature, and which produces energy for use according to the invention, typically in the form of heated carrier liquid vapor (such as steam, when water is used as the carrier) and vaporized reaction products. The resulting high-pressure, high-temperature vapor then proceeds from the catalytic chamber into the interior (340) of the pressure chamber (304), which is designed and constructed for safe handling of the internal pressure load (for example, rated for at least twice the operating pressure) and which is also heavily insulated. This conserves the maximum amount of heat within the chamber, maintaining the interior of the reaction chamber (340) at the desired operating temperature.

As the temperature and internal pressure of the pressure chamber increases, heat is absorbed by the heat-exchanging conduit (322) until an optimum temperature within the pressure chamber is reached. Excessive pressure within the pressure chamber is prevented by pressure release valve (306). Internal sensors, located on the pressure release valve (306) will, upon deployment of the valve under conditions of excess pressure, immediately shut down fuel/oxidizer mixture pump (312), stopping the flow of fuel/oxidizer mixture to the catalytic chamber (334).

The temperature of the fuel/oxidizer mixture being introduced into the reaction chamber (340) is monitored by a temperature sensor (not shown) located near injector (332). If and when needed, the output of the pre-heater (326) may be reduced or shut down and the fuel/oxidizer, at ambient temperature, may be diverted via directional valve (316) through high-pressure feed tube (318) and directly into heat-exchanging conduit (320). The fuel/oxidizer mixture can be heated to a desired temperature, prior to introduction to the catalytic chamber (334), in heat-exchanging conduit (320) using heat transferred from the contained high-temperature vapor.

If the temperature of the fuel/oxidizer mixture introduced via high-pressure tube (330) is determined via temperature sensor (not shown) to be above optimum temperature, control valve (316) is optionally used to send a portion of the pressurized fuel/oxidizer mixture at ambient temperature directly to electric pre-heater (326), held in a non-heating mode. This transfer allows a portion of cooler fuel/oxidizer mixture to mix with the fuel/oxidizer mixture that has passed through the heat exchange conduit (320), thereby reducing the temperature of the fuel/oxidizer mixture introduced into the catalytic chamber (334) and maintaining the optimum feed temperature of the fuel/oxidizer mixture into the catalytic chamber (334). Alternatively, condensed water returned to the reaction chamber after use of the steam generated can be combined with the fuel/oxidizer mixture to reduce the temperature of the fuel/oxidizer mixture introduced into the catalytic chamber (334).

The pre-heated fuel/oxidizer mixture is transported via insulated feed pipe (324), through the inactive pre-heating element (326) and directly into catalytic reaction chamber (334) where catalysis as described above occurs. If the temperature of the pre-heated fuel drops below the desired temperature, electric pre-heater (326) can be switched on and used to raise the temperature of the fuel/oxidizer mixture to the desired temperature if required.

The high-pressure, high-temperature vapor generated is continuously or intermittently transferred to the pressure chamber and may be harvested via exhaust tube (341) via vapor control valve (342) which feeds into output tube (344), to be released for a specific use, such as mechanical work or heating purposes.

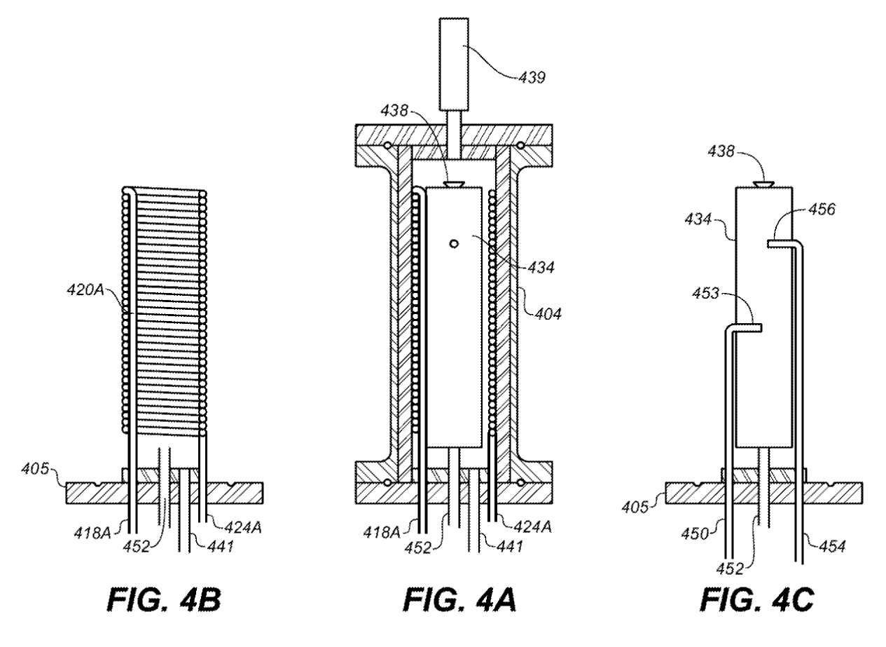

An alternative embodiment of a reaction chamber is depicted in FIG. 4. The center diagram, FIG. 4A, shows a cross section of the reaction chamber. Fuel and/or oxidizer can be introduced into the chamber for pre-heating through an inlet (418A), and passed through an interior tube which is coiled around the periphery of the interior of the chamber, for use as a heat exchanger to preheat the fuel, oxidizing agent, or fuel/oxidizing agent mixture before entry into the internal chamber. The pre-heated fuel, oxidizer, or fuel/oxidizer mixture exits through an outlet (424A). The reaction is initiated with a glow plug on the bottom (not shown) and a pressure relief valve (439) is used at the top if the pressure exceeds the design specifications. Inlet (452) can be used to introduce tertiary substances (such as additional injected water), while outlet (441) can be used to draw off reaction products, such as steam. The left diagram, FIG. 4B, shows the interior tube (420A) used for pre-heating in isolation, with inlet (418A) and outlet (424A). The right diagram, FIG. 4C, details the internal reaction chamber where the chemicals are combined; fuel and oxidizer can be introduced via inlets (450) and (454), respectively, for injection into the reaction chamber at outlets (453) and (456), respectively. Although this diagram shows an upright view, the reaction chamber can be used in various positions, such as in a sideways position (rotated 90 degrees) or in an inverted position (rotated 180 degrees) from that depicted.

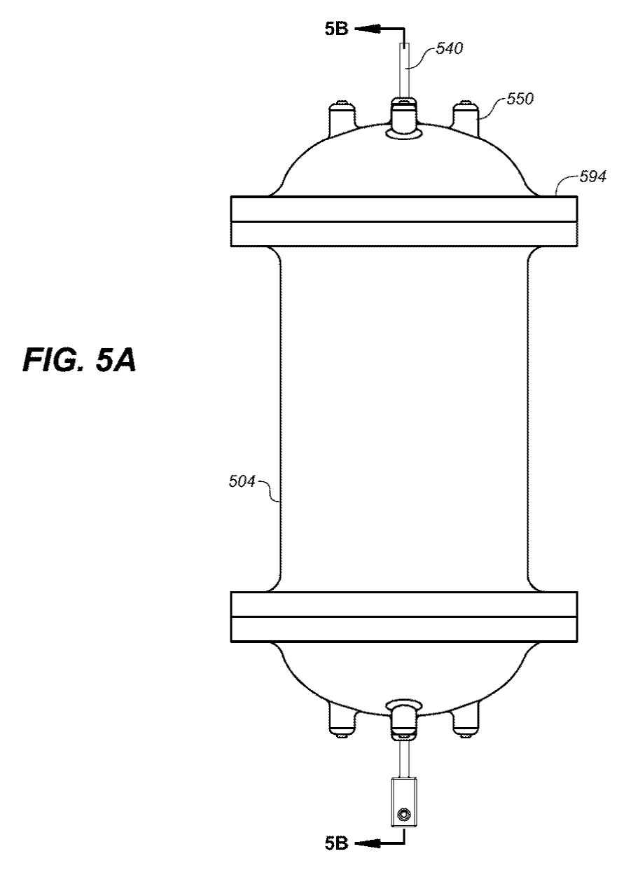

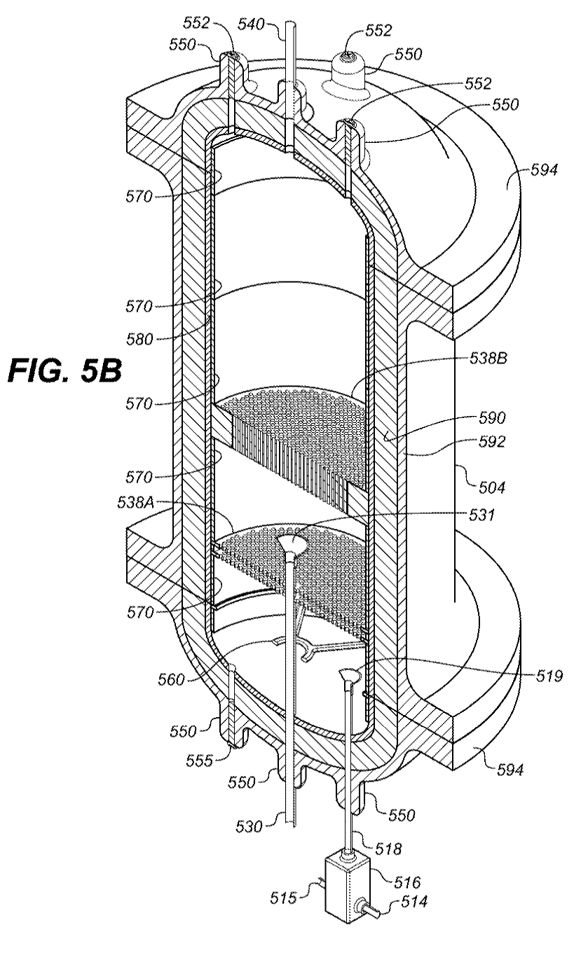

Another embodiment of a reaction chamber suitable for use in the invention is shown in FIG. 5A and FIG. 5B. The reaction chamber main body (504) shown in FIG. 5A can be used vertically as depicted, or in other positions, such as horizontally. FIG. 5B shows a cross-section of the chamber along line 5B of FIG. 5A. A reaction chamber cover (594) is on each end of the main body and connected by bolts that are not depicted in the diagram. There are multiple input/output ports (550). These can be assigned to either a chamber input or output or to any of the feed lines as needed. Each individual input (i.e., fuel, oxidizing agent, or additional substance) can be introduced through one port, or through multiple ports if desired. The exhaust port (540) is another example of a port usage. A feed line can encompass an electric pre-heater (516) as shown here as an example. In this embodiment there is an NH₃ feed input (514), an H₂O feed input (515) and an H₂O₂ feed input (530), allowing direct introduction of these chemicals into the reaction chamber. The reaction chamber has an outer casing layer (592) as well as a heat insulation layer (590). The chamber has an interior non-reactive layer (580) to ensure that there are no additional reactions with the material compounds of the reactor. The chamber interior spacing sleeves (570) are cut in various lengths to position and support catalysts, sensors or feed nozzles as required while maintaining a smooth interior surface within the reaction chamber. An exemplary catalyst plate (538B) and catalyst screen (538A) are shown between the chamber interior spacing sleeves (570). An input feed dispersion nozzle (531) or (519) can be used on any feed input. The reaction chamber has input/output port plugs (552) for all ports that are not currently being used. The reaction chamber bracket (560) can be built in various shapes to assist with the placing of sensors and feed lines or nozzles.

Introduction of Fuel and Oxidizing Agent into Reaction Chamber

The fuel and oxidizing agent can be introduced into a reaction chamber in any form, order, or combination desired, unless a specific form, order, or combination is specified in a particular embodiment. That is, the fuel can be introduced into the reaction chamber as a fluid, a liquid, a solution, a gas, or a mixture of gases, or, in some instances, as a solid, including a solid in suspension in fluid, such as a solid in suspension in a liquid or a solid in suspension in (e.g., entrained in) a gas, or in any combination of the foregoing, unless a specific form is specified in a particular embodiment; the oxidizing agent can be introduced into the reaction chamber in a form independently chosen from the form of the fuel, as a fluid, liquid, a solution, a gas, or a mixture of gases, or, in some instances, as a solid, including a solid in suspension in a liquid or a solid in suspension in (e.g., entrained in) a gas, or any combination of the foregoing, unless a specific form is specified in a particular embodiment. Combinations of the forms of fuel/oxidizing agent can be liquid/liquid, solution/liquid, gas/liquid, mixture of gases/liquid, solid/liquid, liquid/solution, solution/solution, gas/solution, mixture of gases/solution, solid/solution, liquid/gas, solution/gas, gas/gas, mixture of gases/gas, solid/gas, liquid/mixture of gases, solution/mixture of gases, gas/mixture of gases, mixture of gases/mixture of gases, solid/mixture of gases, liquid/solid, solution/solid, gas/solid, mixture of gases/solid, and solid/solid. Any one or more of these combinations can be used in any embodiment of the invention, unless a particular embodiment specifies a particular form. Also, multiple forms of fuel and oxidizing agent can be used, either sequentially, simultaneously, or during overlapping periods. For example, the fuel can be introduced as a liquid, then introduced as a gas and liquid simultaneously, then as a solution, then as a gas and solution simultaneously. The solution forms can be aqueous solutions. Solution forms include an aqueous solution of fuel in water; an aqueous solution of oxidizing agent in water; or when the fuel and oxidizing agent are mixed together prior to introduction into the reaction chamber, an aqueous solution of fuel and oxidizing agent. Forms in the mixture of gases can be mixtures with steam. Forms in the mixture of gases include a mixture of gaseous fuel with steam; a mixture of gaseous oxidizing agent with steam; or when the fuel and oxidizing agent are mixed together prior to introduction into the reaction chamber, a mixture of gaseous fuel, gaseous oxidizing agent, and steam.

For all of the possible forms and combinations of forms of fuel and oxidizing agent, any order of introduction of fuel and oxidizing agent can be used. For example, the fuel can be introduced into the reaction chamber before the oxidizing agent; the oxidizing agent can be introduced into the reaction chamber before the fuel; or fuel and oxidizing agent can be introduced into the reaction chamber during overlapping or simultaneous periods in time.

For all of the possible forms, combination of forms, and order of introduction of fuel and oxidizing agent, the fuel and oxidizing agent can be introduced into the reaction chamber separately; or when possible can be mixed together prior to introduction and thus introduced into the reaction chamber together; or a portion of fuel and oxidizing agent can be mixed together prior to introduction and then introduced into the reaction chamber together when possible, while additional portions of fuel, of oxidizing agent, or of both fuel and oxidizing agent, are added to the reaction chamber without being mixed together prior to introduction into the reaction chamber. Introduction of fuel can occur intermittently or continuously, and introduction of oxidizing agent can occur intermittently or continuously. Combinations of the introduction of fuel/oxidizing agent can be continuous/continuous, continuous/intermittent, intermittent/continuous, intermittent/intermittent, and can be in any order. The introduction of fuel, of oxidizing agent, or of fuel and oxidizing agent can be interrupted for a period of time and then resumed, as desired.

The embodiments and combinations described above for a fuel and an oxidizing agent can also be used for a fuel precursor and an oxidizing agent, or for any or all three of a fuel, a fuel precursor, and an oxidizing agent.

### Catalysts and Other Reaction Accelerants

The rate at which H₂O₂ spontaneously decomposes makes its use in power generation difficult to impractical. For example, in traditional internal combustion engines such a piston engine, the fuel must react in a relatively short period during the power stroke. Catalysis can greatly accelerate decomposition, making H₂O₂ a suitable oxidizing agent for use in mechanical or other work. The speed of this decomposition is determined by many factors, including the amount, type, and morphology/surface area of the catalyst used, the temperature of the catalyst bed, the reaction pressure, the temperature of the feed mixture, the physical presentation of the feed mixture (for example, as fine spray or vapor), and whether other methods of accelerating the reaction, such as a high-voltage arc or radiofrequency energy, are used.

Homogeneous, heterogeneous, or slurry phase catalysts, or a mixture of types of catalyst, can be used. Examples of catalysts that can be used included, but are not limited to, heavy metal-based catalysts such as heavy metal oxides; transition metal-based catalysts such as transition metals and their oxides; metallic catalysts such as those listed in US 2008/0219916; iron and iron-based catalysts including ferrite, Fenton's reagent, and Fe (II)-containing compounds such as iron (II) sulfate; iron-based catalysts such as those disclosed in US 2009/0159502, U.S. Pat. No. 5,755,977, or JP 2005063902 A; chromium-based catalysts such as chromic acid and dichromate (Bobtelsky et al., J. Am. Chem. Soc. 67(6):966-975 (1945)); cerium and cerium-based catalysts such as cerium oxide; MoO₃; manganese and manganese-based catalysts such as MnO₂, MnO, or KMnO₄ (see U.S. Pat. No. 7,070,878) or those disclosed in U.S. Pat. No. 5,755,977; tungsten and tungsten-based catalysts such as tungsten oxide; a zinc triad element (zinc, cadmium, or mercury) or zinc triad element oxide; a nickel triad metal (nickel, palladium, or platinum) or nickel triad metal oxide; a platinum group metal (platinum, palladium, ruthenium, rhodium, iridium, osmium) or platinum group metal oxide; a lanthanide or lanthanide oxide, such as M₂O₃-type lanthanide oxides and La₂O₃; an actinide or actinide oxide; copper and copper-based catalysts such as copper (II) sulfate; aluminum-based catalysts such as calcined alumina and aluminosilicates; zeolites such as those listed in US 2009/0159502; potassium permanganate; compounds of the form MFe₂O₄ and MCo₂O₄ where M is selected from the group consisting of Mn, Fe, Co, Ni, Zn, and Mg (Mimani et al., Journal of Chemical Sciences 99(4):209-215 (1987)); titanium and titanium-based catalysts such as Ti(III)-containing compounds, Ti(IV)-containing compounds, titanium oxide (that is, titania, in any crystalline or non-crystalline form or combinations thereof, including rutile, anatase, brookite, or amorphous); titania-tungsten mixtures; vanadium; palladium; platinum; ruthenium; iridium; or silver; or silicon dioxide, quartz, or borosilicate glass; magnesium oxide; protein catalysts such as catalase; or any combination thereof. The catalysts are, or can be, supported on an inert matrix. They can be in the form of beads, particles, wire screens, meshes, sponges, or any other form suitable for catalysis.

In addition to catalysts, other agents can be employed to accelerate the rate of reaction, such as a high-voltage arc (such as a spark plug), or various high-energy frequencies or high-energy radiation, such as radiofrequency energy or laser radiation, or any combination thereof.

The catalytic agent(s) can be disposed in a manner to maximize the available surface area of the agent or agents, while the agent(s) can be secured on a matrix to prevent ablation and migration, and to allow for the maximum flow of liquid and vapor through the reaction chamber with a minimum of impedance. Such dispositions may include metallic or ceramic sponges, microtubules, beads, or screens.

### Reaction Additives

Additional substances can be added to the reaction in order to accelerate the reaction. Such additives include nitrates, such as ammonium nitrate, sodium nitrate, potassium nitrate, and other inorganic nitrates. Nitric acid can also be used. Other additives include perchlorates, such as ammonium perchlorate, sodium perchlorate, potassium perchlorate, and other inorganic perchlorates. Perchloric acid can also be used. The skilled artisan will recognize these additives as powerful oxidizing agents, with attendant explosion and corrosion hazards. In some embodiments, any one or more of these additives are used only during the initial start-up of the reaction chamber, in order to reach a desired operating temperature and pressure more rapidly. In other embodiments, any one or more of these additives can be added continuously or intermittently during operation of the reaction chamber. In some embodiments, the additives are used in aqueous solution, such as dilute aqueous solution, to minimize explosion and corrosion hazards associated with the additives.

Ammonium nitrate and ammonium perchlorate can also be used as combination fuels, that is, as fuels that combine the ammonia fuel and oxidizing agent in one substance (see the section entitled “single-chemical fuel/oxidizing agent combinations”).

### Operating Temperature and Pressure

Upon reaction with either a catalytic-based, electrical/RF discharge or thermal source, an optimum operating temperature of a fuel mixture would be in the range of about 600° C. to about 1500° C. with an optimal pressure of about 25 bar to 250 bar, such as about 200 bar to 250 bar. The optimal temperatures and pressures will vary depending on the size and desired power output for the end use. For example, a mechanical device such as a small engine capable of effectively powering a lawn-mower would require lower temperature and pressure than a larger engine capable of propelling a vehicle or powering a generator. Steam generation for residential heating can be generated at a significantly lower pressure and temperature than steam used for industrial processes such as fractional distillation.

When a substance that can occur as either a liquid or a gas is maintained at both very high temperatures and very high pressures, the phase boundary between liquid and gas disappears, and the substance possesses properties of both liquids and gases. The point on a phase diagram where this behavior occurs is called the critical point, and the material is described as a critical fluid or supercritical fluid. The critical point for water occurs at 347° C. and 220 bar (about 217 atm); the density of water at its critical point is 322 kg/m³. (See The International Association for the Properties of Water and Steam, Release on the Values of Temperature, Pressure and Density of Ordinary and Heavy Water Substances at Their Respective Critical Points, in Physical Chemistry of Aqueous Systems, Proc. 12th ICPWS, Orlando, Fla., 1994, H. J. White, Jr., J. V. Sengers, D. B. Neumann, and J. C. Bellows, ed. Begell House, New York (1995), available at URL World-Wide-Web.iapws.org/relguide/fundam.pdf). In certain embodiments of the invention, the temperature and the pressure of the reaction chamber can exceed the critical point of the medium in which it takes place, and the medium is in its critical phase. For example, when the reaction is run in water at 250 bar and 1000° C., the water present is in its critical phase, also referred to as critical phase water, supercritical water, or supercritical steam.

### Generation of High-Temperature Gas, High-Temperature Vapor, High-Pressure Gas, High-Pressure Vapor, or Supercritical Fluid

Certain embodiments of the invention serve to generate high-pressure gas or high-pressure vapor, high-temperature gas or high-temperature vapor, or supercritical fluid for use in a variety of applications. High-temperature gas or high-temperature vapor can be used for central heating, for example, while high-pressure gas or high-pressure vapor or supercritical fluid can be used with a turbine for generation of electricity. The supercritical fluid can be used in an expansion piston and/or turbine engine for the generation of electricity.

The reaction of the fuel and oxidizing agent releases energy. The Ideal Gas Law, PV=nRT, describes the relationship of pressure P and volume V with the amount of gas, n (in moles), the temperature T, and the ideal gas constant R. For a fixed amount of gas, PV/T is constant. The combined gas law (which combines Charles's law, Boyle's law, and Gay-Lussac's law) for ideal gases states that:

P₁V₁/T₁=P₂V₂/T₂

(where P₁, V₁, and T₁ are a first set of conditions of pressure, volume, and temperature, and P₂, V₂, and T₂ are a second set of conditions).

For a given amount of gas in a constant volume (that is, V₁=V₂), the combined gas law reduces to Gay-Lussac's law,

P₁/T₁=P₂/T₂.

Thus, for an ideal gas in a constant volume, raising the temperature will raise the pressure, and raising the pressure will raise the temperature.

One embodiment of the invention embraces a system and a method of producing high-temperature gas or high-temperature vapor. In the method, a fuel and an oxidizing agent are introduced into a reaction chamber. The fuel and oxidizing agent can be introduced during different time periods, simultaneously during the same time period, or during overlapping time periods. The fuel and oxidizing agent can be introduced in batches (that is, discrete amounts are introduced), or can be introduced continuously, or can be introduced in an alternating manner (that is, fuel is introduced for a period of time, then oxidizing agent is introduced during a period of time, then more fuel is introduced for a period of time, then more oxidizing agent is introduced during a period of time, etc.).

The molecular formula of the fuel can comprise nitrogen and hydrogen and essentially exclude carbon not already fully oxidized. The molecular formula of the fuel can comprise nitrogen and hydrogen and essentially exclude oxidizable carbon. The molecular formula of the fuel can comprise nitrogen and hydrogen and essentially include only non-oxidizable carbon. Alternatively, the molecular formula of the fuel can consist essentially of nitrogen, hydrogen, and optionally oxygen and/or carbonate and/or carbonic acid derivatives and/or fully oxidized carbon. The fuel and oxidizing agent are reacted to produce energy. At least one additional substance can be introduced into the reaction chamber, where the heat produced in the reaction transforms the at least one additional substance into a high-temperature gas or high-temperature vapor. The at least one additional substance can be introduced into the reaction chamber before, during, or after introducing the fuel and/or oxidizing agent into the reaction chamber.

The introduced at least one additional substance can be a liquid, in which case production of high-temperature gas or high-temperature vapor involves evaporation of the liquid; or the introduced at least one additional substance can be a gas, in which case the introduced gaseous additional substance is heated to a higher temperature. An example of a liquid which can be introduced includes (but is not limited to) water, which can be evaporated into steam. An example of a gas which can be introduced includes (but is not limited to) low temperature steam, which can be heated to produce high-temperature steam.

In some embodiments, the temperature of the high-temperature gas or high-temperature vapor is at least about 25° C. above ambient temperature. In some embodiments, the temperature of the high-temperature gas or high-temperature vapor is at least about 50° C. above ambient temperature. In some embodiments, the temperature of the high-temperature gas or high-temperature vapor is at least about 100° C. above ambient temperature. In some embodiments, the temperature of the high-temperature gas or high-temperature vapor is about 75° C. or above about 75° C. In some embodiments, the temperature of the high-temperature gas or high-temperature vapor is about 100° C. or above about 100° C. In some embodiments, the temperature of the high-temperature gas or high-temperature vapor is about 200° C. or above about 200° C. In some embodiments, the temperature of the high-temperature gas or high-temperature vapor is about 300° C. or above about 300° C. In some embodiments, the temperature of the high-temperature gas or high-temperature vapor is about 500° C. or above about 500° C. In some embodiments, the temperature of the high-temperature gas or high-temperature vapor is about 600° C. or above about 600° C. In some embodiments, the temperature of the high-temperature gas or high-temperature vapor is about 750° C. or above about 750° C. In some embodiments, the temperature of the high-temperature gas or high-temperature vapor is about 1000° C. or above about 1000° C. In some embodiments, the temperature of the high-temperature gas or high-temperature vapor is about 1100° C. or above about 1100° C. In some embodiments, the temperature of the high-temperature gas or high-temperature vapor is about 1200° C. or above about 1200° C. In some embodiments, the temperature of the high-temperature gas or high-temperature vapor is about 1300° C. or above about 1300° C. In some embodiments, the temperature of the high-temperature gas or high-temperature vapor is about 1400° C. or above about 1400° C. In some embodiments, the temperature of the high-temperature gas or high-temperature vapor is about 1500° C. or above about 1500° C. In other embodiments, any two of the foregoing temperatures can be combined to form a temperature range, for example “about 600° C.” can be combined with “about 1200° C.” to form the range for the temperature of the high-temperature gas or high-temperature vapor of between about 600° C. to about 1200° C. In some embodiments, the temperature of the high-temperature gas or high-temperature vapor is between about 50° C. to about 100° C. In some embodiments, the temperature of the high-temperature gas or high-temperature vapor is between about 50° C. to about 200° C. In some embodiments, the temperature of the high-temperature gas or high-temperature vapor is between about 50° C. to about 300° C. In some embodiments, the temperature of the high-temperature gas or high-temperature vapor is between about 50° C. to about 500° C. In some embodiments, the temperature of the high-temperature gas or high-temperature vapor is between about 50° C. to about 750° C. In some embodiments, the temperature of the high-temperature gas or high-temperature vapor is between about 50° C. to about 1000° C. In some embodiments, the temperature of the high-temperature gas or high-temperature vapor is between about 50° C. to about 1200° C. In some embodiments, the temperature of the high-temperature gas or high-temperature vapor is between about 600° C. to about 1000° C. In some embodiments, the temperature of the high-temperature gas or high-temperature vapor is between about 600° C. to about 1100° C. In some embodiments, the temperature of the high-temperature gas or high-temperature vapor is between about 600° C. to about 1200° C. In some embodiments, the temperature of the high-temperature gas or high-temperature vapor is between about 600° C. to about 1300° C. In some embodiments, the temperature of the high-temperature gas or high-temperature vapor is between about 600° C. to about 1400° C. In some embodiments, the temperature of the high-temperature gas or high-temperature vapor is between about 600° C. to about 1500° C.

Another embodiment of the invention embraces a system and method of producing high-pressure gas or high-pressure vapor. In the method, a fuel and an oxidizing agent are introduced into a reaction chamber. The fuel and oxidizing agent can be introduced during different time periods, simultaneously during the same time period, or during overlapping time periods. The fuel and oxidizing agent can be introduced in batches (that is, discrete amounts are introduced), or can be introduced continuously, or can be introduced in an alternating manner (that is, fuel is introduced for a period of time, then oxidizing agent is introduced during a period of time, then more fuel is introduced for a period of time, then more oxidizing agent is introduced during a period of time, etc.).

The molecular formula of the fuel can comprise nitrogen and hydrogen and essentially exclude carbon not already fully oxidized. The molecular formula of the fuel can comprise nitrogen and hydrogen and essentially exclude oxidizable carbon. The molecular formula of the fuel can comprise nitrogen and hydrogen and essentially include only non-oxidizable carbon. Alternatively, the molecular formula of the fuel can consist essentially of nitrogen, hydrogen, and optionally oxygen and/or carbonate or carbonic acid derivatives and/or fully oxidized carbon. The fuel and oxidizing agent are reacted to produce energy. At least one additional substance can be introduced into the reaction chamber, where the energy produced in the reaction transforms the at least one additional substance into a high-pressure gas or high-pressure vapor. The at least one additional substance can be introduced into the reaction chamber before, during, or after introducing the fuel and/or oxidizing agent into the reaction chamber.

The introduced at least one additional substance can be a fluid, such as a liquid, in which case production of high-pressure gas or high-pressure vapor involves evaporation of the liquid, or the introduced at least one additional substance can be a fluid, such as a gas, in which case introduction of the at least one additional substance raises the pressure of the gas. An example of a liquid which can be introduced includes (but is not limited to) water, which can be evaporated into steam. An example of a gas which can be introduced includes (but is not limited to) low-pressure steam, which can be heated to produce high-pressure steam.

In some embodiments, the pressure of the high-pressure gas or high-pressure vapor is about 10 bar or above about 10 bar. In some embodiments, the pressure of the high-pressure gas or high-pressure vapor is about 25 bar or above about 25 bar. In some embodiments, the pressure of the high-pressure gas or high-pressure vapor is about 50 bar or above about 50 bar. In some embodiments, the pressure of the high-pressure gas or high-pressure vapor is about 75 bar or above about 75 bar. In some embodiments, the pressure of the high-pressure gas or high-pressure vapor is about 100 bar or above about 100 bar. In some embodiments, the pressure of the high-pressure gas or high-pressure vapor is about 150 bar or above about 150 bar. In some embodiments, the pressure of the high-pressure gas or high-pressure vapor is about 200 bar or above about 200 bar. In some embodiments, the pressure of the high-pressure gas or high-pressure vapor is about 250 bar or above about 250 bar. In some embodiments, the pressure of the high-pressure gas or high-pressure vapor is about 300 bar or above about 300 bar. In some embodiments, the pressure of the high-pressure gas or high-pressure vapor is about 500 bar or above about 500 bar. In some embodiments, the pressure of the high-pressure gas or high-pressure vapor is about 750 bar or above about 750 bar. In some embodiments, the pressure of the high-pressure gas or high-pressure vapor is about 1000 bar or above about 1000 bar. In other embodiments, any two of the foregoing pressures can be combined to form a pressure range, for example “about 100 bar” can be combined with “about 500 bar” to form the range of pressure of the high-pressure gas or high-pressure vapor of between about 100 bar to about 500 bar. In some embodiments, the pressure of the high-pressure gas or high-pressure vapor is between about 50 bar to about 100 bar. In some embodiments, the pressure of the high-pressure gas or high-pressure vapor is between about 50 bar to about 200 bar. In some embodiments, the pressure of the high-pressure gas or high-pressure vapor is between about 50 bar to about 300 bar. In some embodiments, the pressure of the high-pressure gas or high-pressure vapor is between about 50 bar to about 500 bar. In some embodiments, the pressure of the high-pressure gas or high-pressure vapor is between about 50 bar to about 750 bar. In some embodiments, the pressure of the high-pressure gas or high-pressure vapor is between about 50 bar to about 1000 bar. In some embodiments, the pressure of the high-pressure gas or high-pressure vapor is between about 25 bar to about 250 bar, such as about 200 bar to about 250 bar.

Steam (water vapor) is a convenient medium that can be used for a variety of applications, such as heating systems, mechanical work, or generation of electricity. Steam turbines, for example, are widely used to generate electricity. Steam has been intensively studied, and the conditions under which it approximates ideal gas behavior as well as the conditions under which it deviates from ideal gas behavior are well-known.

Another embodiment of the invention embraces a system and method of producing supercritical fluid. In the method, a fuel and an oxidizing agent are introduced into a reaction chamber. The fuel and oxidizing agent can be introduced during different time periods, simultaneously during the same time period, or during overlapping time periods. The fuel and oxidizing agent can be introduced in batches (that is, discrete amounts are introduced), or can be introduced continuously, or can be introduced in an alternating manner (that is, fuel is introduced for a period of time, then oxidizing agent is introduced during a period of time, then more fuel is introduced for a period of time, then more oxidizing agent is introduced during a period of time, etc.).

The molecular formula of the fuel can comprise nitrogen and hydrogen and essentially exclude carbon not already fully oxidized. The molecular formula of the fuel can comprise nitrogen and hydrogen and essentially exclude oxidizable carbon. The molecular formula of the fuel can comprise nitrogen and hydrogen and essentially include only non-oxidizable carbon. Alternatively, the molecular formula of the fuel can consist essentially of nitrogen, hydrogen, and optionally oxygen and/or carbonate or carbonic acid derivatives and/or fully oxidized carbon. The fuel and oxidizing agent are reacted to produce energy. At least one additional substance can be introduced into the reaction chamber, where the energy produced in the reaction transforms the at least one additional substance into supercritical fluid. The at least one additional substance can be introduced into the reaction chamber before, during, or after introducing the fuel and/or oxidizing agent into the reaction chamber.

The introduced at least one additional substance can be a fluid, such as a liquid or a gas. An example of a liquid which can be introduced includes (but is not limited to) water. Examples of gases which can be introduced include (but are not limited to) low-pressure steam and high-pressure steam.

Supercritical steam (supercritical water) is useful for power generation, for example, for use in turbines to generate electricity.

### Example Illustrating Reactor Output

An experiment was conducted using a reactor body design based on the standard ASME Class 2500 welded pipe and flange designs. The reactor was made of stainless steel. The reactor was designed to accommodate a support structure for catalyst beds. The main body of the reactor had an internal central diameter of 1.875 inches and a length of 9 inches. This created a suitable aspect ratio given a residence time of about 1 second using the specified gas flow rates herein.

The fuels were introduced into this reactor at a reactor pressure of 1000 psig and increased to 1500 psig and 2000 psig throughout the experiment, causing an increase in the saturated steam gas temperature.

The fuel feed rates were 155 to 170 milliliters per minute for the aqueous solution of NH₃ (28% NH₃ in water) and 165 milliliters per minute for the aqueous solution of H₂O₂ (50% H₂O₂ in water), with a molar ratio range of H₂O₂:NH₃ varying from 1-2 (the stoichiometric ratio is 1.5).

A catalyst bed was used, comprised of 12 activated platinum screens and 4 activated silver screens.

The temperature of the gas output from the reactor at 1000 psi was 275 degrees Celsius with a steam output rate of 44 pounds per hour. The power available for work created by this experiment was 21.2 horsepower, or in metric units, 15,800 joules per second (watts).

The disclosures of all publications, patents, patent applications and published patent applications referred to herein by an identifying citation are hereby incorporated herein by reference in their entirety. To access a Uniform Resource Locator (URL) listed herein, for example, listed herein as World-Wide-Web.uspto.gov, the string “World-Wide-Web” should be replaced by “www” to reconstitute the active hyperlink.

Although the foregoing invention has been described in some detail by way of illustration and example for purposes of clarity of understanding, it is apparent to those skilled in the art that certain changes and modifications will be practiced. Therefore, the description and examples should not be construed as limiting the scope of the invention.

What is claimed is:

1. A system for generation of energy, comprising:
a fuel or fuel precursor having a molecular formula comprising nitrogen and hydrogen, said fuel or fuel precursor essentially excluding oxidizable carbon;
an oxidizing agent, and
a reaction chamber into which the fuel or fuel precursor and oxidizing agent can be introduced, and in which the fuel or fuel precursor and oxidizing agent can react in an aqueous solution, in steam, or in supercritical steam.

2. The system of claim 1, wherein, prior to introduction into the reaction chamber, the fuel or fuel precursor, the oxidizing agent, or both the fuel or fuel precursor and the oxidizing agent can be a fluid, a liquid, a solution, a gas, a mixture of gases, a solid, a solid in suspension in a fluid, a solid in suspension in a liquid, a solid in suspension in a gas, or any combination thereof.

3. The system of claim 1, wherein, prior to introduction into the reaction chamber, the fuel or fuel precursor, the oxidizing agent, or both the fuel or fuel precursor and the oxidizing agent are in aqueous solution.

4. The system of claim 1, wherein the fuel or fuel precursor and oxidizing agent can react in the reaction chamber to release energy.

5. The system of claim 4, wherein the energy released can be used to heat liquid water to form steam or supercritical steam.

6. The system of claim 1, wherein the fuel is selected from the group consisting of ammonia, ammonia gas, anhydrous ammonia, ammonium hydroxide, ammonium nitrate, ammonium perchlorate, hydroxylamine, hydrazine, ammonium bicarbonate, and ammonium carbonate.

7. The system of claim 6, wherein the fuel is ammonia or ammonium hydroxide.

8. The system of claim 1, wherein the fuel precursor is urea.

9. The system of claim 1, wherein the oxidizing agent is selected from the group consisting of hydrogen peroxide, nitric acid, nitrous oxide, nitric oxide, nitrogen dioxide, nitrogen tetroxide, and sodium percarbonate.

10. The system of claim 9, wherein the oxidizing agent is hydrogen peroxide.

11. The system of claim 1, wherein the reaction chamber comprises or contains one or more catalysts.

12. The system of claim 11, wherein the catalyst is a catalyst for the decomposition of the oxidizing agent, the decomposition of the fuel, the composition of the fuel precursor, the decomposition of the fuel precursor and the fuel, the decomposition of the oxidizing agent and the fuel precursor, the decomposition of the oxidizing agent and the fuel, or the decomposition of the oxidizing agent, the fuel precursor, and the fuel.

13. The system of claim 11, wherein the catalyst is a transition metal or transition metal oxide.

14. A system for generation of energy, comprising:
a reservoir of a fuel or fuel precursor, said fuel or fuel precursor having a molecular formula consisting essentially of nitrogen, hydrogen, and optionally oxygen and/or carbonate and/or carbonic acid derivatives and/or fully oxidized carbon;
a reservoir of an oxidizing agent, and
a reaction chamber into which the fuel or fuel precursor and oxidizing agent can be introduced, and in which the fuel or fuel precursor and oxidizing agent can react in an aqueous solution, in steam, or in supercritical steam.

15. The system of claim 14, wherein the fuel is ammonia or ammonium hydroxide and wherein the oxidizing agent is hydrogen peroxide.

16. A system comprising:
a fuel or fuel precursor having a molecular formula comprising nitrogen and hydrogen, said fuel or fuel precursor essentially excluding oxidizable carbon;
an oxidizing agent; and
a reaction chamber into which the fuel or fuel precursor and oxidizing agent can be introduced and reacted;
wherein said reaction chamber is a combustion chamber or expansion chamber of an internal combustion engine.

17. The system of claim 16, wherein the combustion chamber or expansion chamber of an internal combustion engine is selected from the group consisting of a combustion chamber or expansion chamber of a piston engine, a combustion chamber or expansion chamber of a rotary engine, and a combustion chamber or expansion chamber of a turbine.

18. The system of claim 16, wherein the combustion chamber or expansion chamber of an internal combustion engine further comprises or contains one or more catalysts for the decomposition of the oxidizing agent, the decomposition of the fuel, the composition of the fuel precursor, the decomposition of the fuel precursor and the fuel, the decomposition of the oxidizing agent and the fuel precursor, the decomposition of the oxidizing agent and the fuel, or the decomposition of the oxidizing agent, the fuel precursor, and the fuel.

19. A system for generation of energy, comprising:
a fuel or fuel precursor having a molecular formula comprising nitrogen and hydrogen, said fuel or fuel precursor essentially excluding oxidizable carbon;
an oxidizing agent;
a reaction chamber into which the fuel or fuel precursor and oxidizing agent can be introduced; and
a working fluid to which heat is transferred from the reaction chamber.

20. The system of claim 19, wherein the working fluid is the working fluid of an external combustion engine.

21. A system for generation of energy, comprising:
a fuel or fuel precursor having a molecular formula comprising nitrogen and hydrogen, said fuel or fuel precursor essentially excluding oxidizable carbon;
an oxidizing agent, and
a reaction chamber into which the fuel or fuel precursor and oxidizing agent can be introduced;
with the proviso that the system is not a reaction engine or rocket engine.

22. A method for generation of pressurized gas or pressurized vapor, comprising:
introducing a fuel or fuel precursor and an oxidizing agent into a reaction chamber, wherein the fuel or fuel precursor and oxidizing agent can be introduced sequentially in any order, simultaneously, or during overlapping periods of time, wherein the molecular formula of the fuel or fuel precursor comprises nitrogen and hydrogen and said fuel or fuel precursor essentially excludes oxidizable carbon; and
reacting the fuel or fuel precursor and oxidizing agent to produce a pressurized gas or pressurized vapor.

23. The method of claim 22, further comprising at least one additional step selected from the group consisting of: using the pressurized gas or pressurized vapor to generate electricity, using the pressurized gas or pressurized vapor to generate electricity using a turbine, using the pressurized gas or pressurized vapor to generate electricity using an external combustion engine, or using the pressurized gas or pressurized vapor for heating.

24. The method of claim 22, further comprising:
introducing at least one additional substance into the reaction chamber before, during, or after introducing the fuel or fuel precursor and/or oxidizing agent into the reaction chamber; and
transforming the at least one additional substance into a pressurized gas or pressurized vapor.

25. The method of claim 24, wherein the at least one additional substance is a liquid, and the transforming of the at least one additional substance into a pressurized gas or pressurized vapor comprises evaporating the liquid.

26. The method of claim 25, wherein the liquid comprises water.

27. The method of claim 24, wherein the at least one additional substance is a gas, and the transforming of the at least one additional substance into a pressurized gas or pressurized vapor comprises raising the pressure of the introduced gas substance by transfer of energy to the additional substance.

28. The method of claim 27, wherein the at least one additional substance is low-pressure steam, supplemental steam, or supplemental water.

29. The method of claim 22, wherein the pressurized gas or pressurized vapor is at a pressure at or above about 25 bar.

30. A method for generation of high-temperature gas or high-temperature vapor, comprising:
introducing a fuel or fuel precursor and an oxidizing agent into a reaction chamber, wherein the fuel or fuel precursor and oxidizing agent can be introduced sequentially in any order, simultaneously, or during overlapping periods of time, wherein the molecular formula of the fuel or fuel precursor comprises nitrogen and hydrogen and essentially excludes oxidizable carbon; and
reacting the fuel or fuel precursor and oxidizing agent to produce a high-temperature gas or high-temperature vapor.

31. The method of claim 30, further comprising at least one additional step selected from the group consisting of: using the high-temperature gas or high-temperature vapor to generate electricity, using the high-temperature gas or high-temperature vapor to generate electricity using a turbine, using the high-temperature gas or high-temperature vapor to generate electricity using an external combustion engine, or using the high-temperature gas or high-temperature vapor for heating.

32. The method of claim 30, further comprising:
introducing at least one additional substance into the reaction chamber before, during, or after introducing the fuel or fuel precursor and/or oxidizing agent into the reaction chamber; and
transforming the at least one additional substance into a high-temperature gas or high-temperature vapor.

33. The method of claim 32, wherein the at least one additional substance is a liquid, and the transforming of the at least one additional substance into a high-temperature gas or high-temperature vapor comprises evaporating the liquid.

34. The method of claim 33, wherein the liquid comprises water.

35. The method of claim 32, wherein the at least one additional substance is a gas, and the transforming of the at least one additional substance into a high-temperature gas or high-temperature vapor comprises raising the temperature of the introduced gas substance by transfer of energy to the at least one additional substance.

36. The method of claim 35, wherein the at least one additional substance is low-temperature steam.

37. The method of claim 30, wherein the high-temperature gas or high-temperature vapor is at a temperature at or above about 200° C.

38. A method for generation of a supercritical fluid, comprising:
introducing a fuel or fuel precursor and an oxidizing agent into a reaction chamber, wherein the fuel or fuel precursor and oxidizing agent can be introduced sequentially in any order, simultaneously, or during overlapping periods of time, wherein the molecular formula of the fuel or fuel precursor comprises nitrogen and hydrogen and essentially excludes oxidizable carbon;
reacting the fuel or fuel precursor and oxidizing agent to produce energy; and
introducing at least one additional substance into the reaction chamber before, during, or after introducing the fuel or fuel precursor and/or oxidizing agent into the reaction chamber; and
transforming the at least one additional substance into a supercritical fluid.

39. The method of claim 38, further comprising at least one additional step selected from the group consisting of: using the supercritical fluid to generate electricity, using the supercritical fluid to generate electricity using a turbine, using the supercritical fluid to generate electricity using an external combustion engine, or using the supercritical fluid for heating.

40. The method of claim 39, further comprising:
introducing at least one additional substance into the reaction chamber before, during, or after introducing the fuel and/or oxidizing agent into the reaction chamber; and
transforming the at least one additional substance into a supercritical fluid.

41. The method of claim 40, wherein the at least one additional substance comprises water.
